(19) United States
(12) Patent Application Publication
(10) Pub. No.: US 2005/0052558 A1
(43) Pub. Date: Mar. 10, 2005

(54) Information processing apparatus, information processing method and software product

(75) Inventors: Masahiro Yamazaki, Yokohama (JP); Hideki Kuwamoto, Fujisawa (JP)

Correspondence Address: McDermott, Will & Emery, 600, 13th Street, N.W., Washington, DC, 20005-3096, US

(73) Assignee: HITACHI, LTD.

(21) Appl. No.: 10/922,080

(22) Filed: Aug. 20, 2004

(30) Foreign Application Priority Data
Sep. 9, 2003 (JP) 2003-316179

(51) Int. Cl. H04N 5/222

(52) U.S. Cl. 348/333.12

(57) ABSTRACT

A disclosed information processing apparatus comprises a camera which outputs picture information of an object, a display, and an input unit. In one example, the input unit allows a user to select one mode among an ordinary image-taking mode and a character recognition mode. The camera may be positioned to make a displayed image of the object substantially consistent with a view of the object by a user. In another example, the input unit enables selection of an information type. The CPU extracts a character string corresponding to the selected information type. Also, identification information included in a recognized character string may be transmitted via a network when an user requests for information related to the recognized character.

This application claims the benefit of priority of Japanese Application No. 2003-316179 filed Sep. 9, 2003, the disclosure of which also is entirely incorporated herein by reference.

### TECHNICAL FIELD

The present invention relates to an information processing apparatus such as a cellular phone, a PHS (Personal Handy-phone System), a PDA (Personal Digital Assistant) or a laptop or handheld Personal Computer as well as to an information-processing method adopted by the apparatus and software used in the apparatus.

### BACKGROUND

Japanese Patent Laid-open No. 2002-252691 has disclosed a portable phone terminal capable of inputting printed information such as an address, a phone number and a URL (uniform resource locator) by using an OCR (optical character recognition) function.

It may be difficult for the user specify an area of recognition because of a difference between the position of a character actually written on a paper and that of the character displayed on the display.

There is a need for an improved method of processing information and an improved information processing apparatus.

### SUMMARY

The above stated need is met by an information processing apparatus that comprises a camera which outputs picture information of an object, a display which displays an image using the picture information output from the camera, and an input unit which allows a user to select one mode of the camera from a plurality of modes including an ordinary image-taking mode to take a picture as an ordinary camera function and a recognition mode to recognize a character included in a picture information output by the camera. The camera is positioned to make a displayed image of the object substantially consistent with a view of the object by a user.

To make an user operation of pointing out recognition area easier, an information processing apparatus includes a picture interface which inputs picture information into the information processing apparatus, and an input unit which inputs a selection of an information type. The information processing apparatus also has a CPU which extracts a string of one or more characters corresponding to the information type input by the input unit if present in the picture information input by the picture interface, in response to a character recognition request by a user.

To acquire information related to a recognized character string easily, an information processing method includes the following steps. A picture information is received, and a string of one or more characters is recognized from the picture information. Identification information included in the recognized character string is transmitted via a network when an user requests for information related to the recognized character. Information related to the identification information is received, and the received information is displayed.

### BRIEF DESCRIPTION OF THE INVENTION

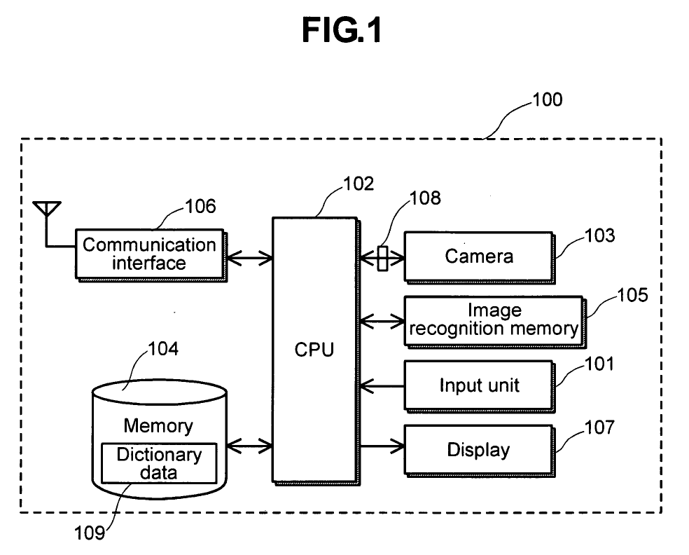

FIG. 1 is a block diagram of an information processing apparatus.

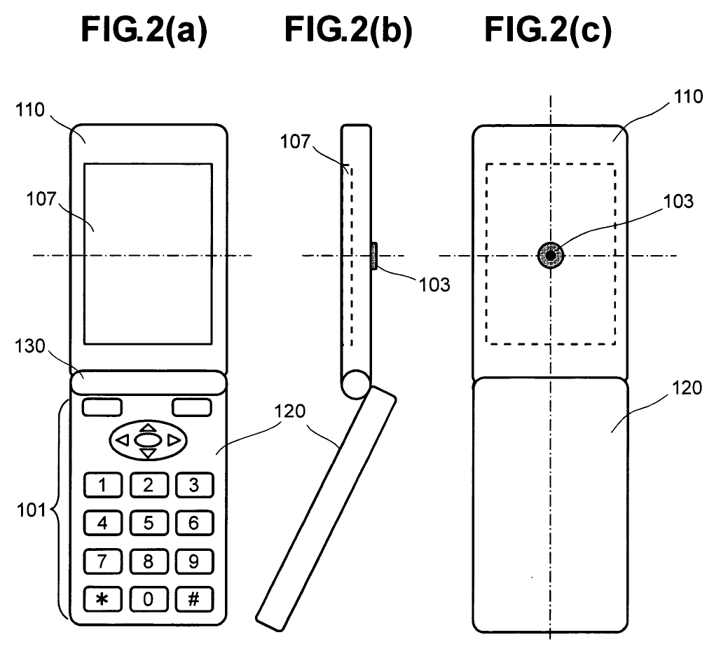

FIG. 2 (consisting of 2(a) to 2(c)) is an external view of a cellular phone.

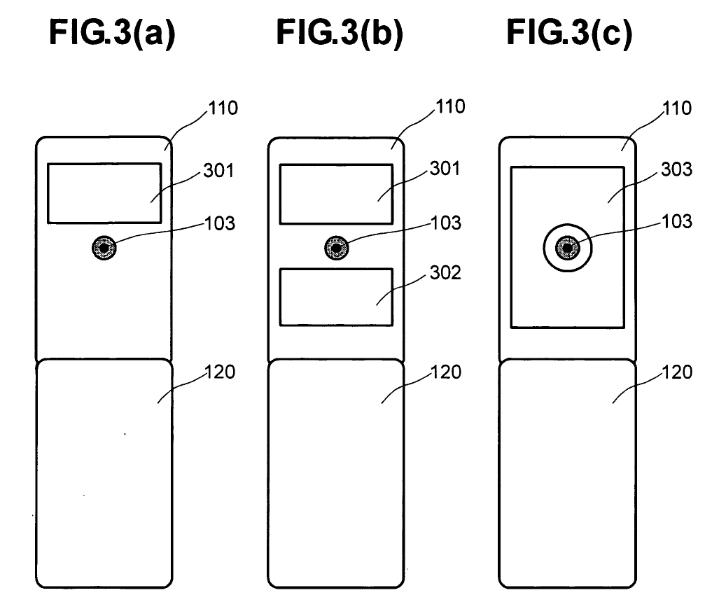

FIG. 3 (consisting of 3(a) to 3(c)) is an external view of a cellular phone.

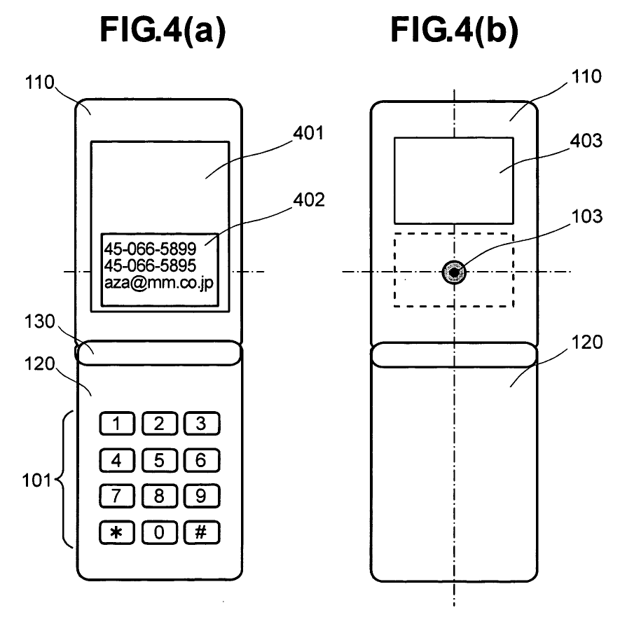

FIG. 4 (consisting of 4(a) to 4(b)) is an external view of a cellular phone.

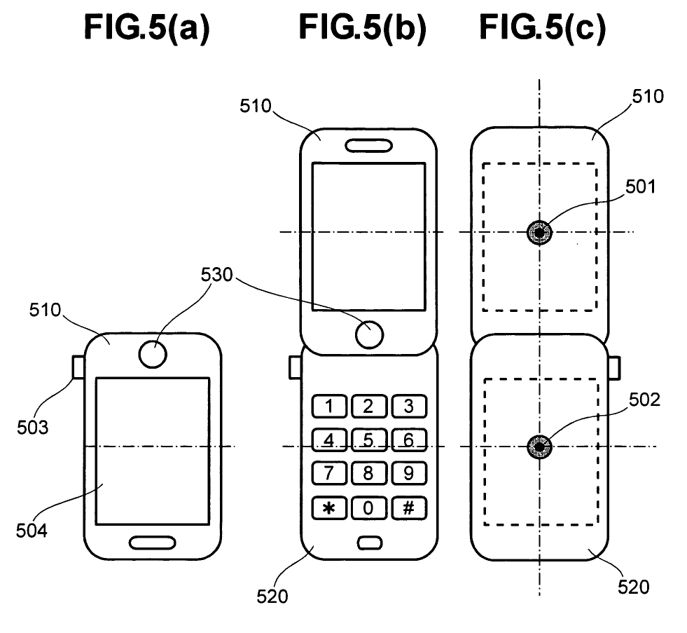

FIG. 5 (consisting of 5(a) to 5(c)) is an external view of a rotatable type cellular phone.

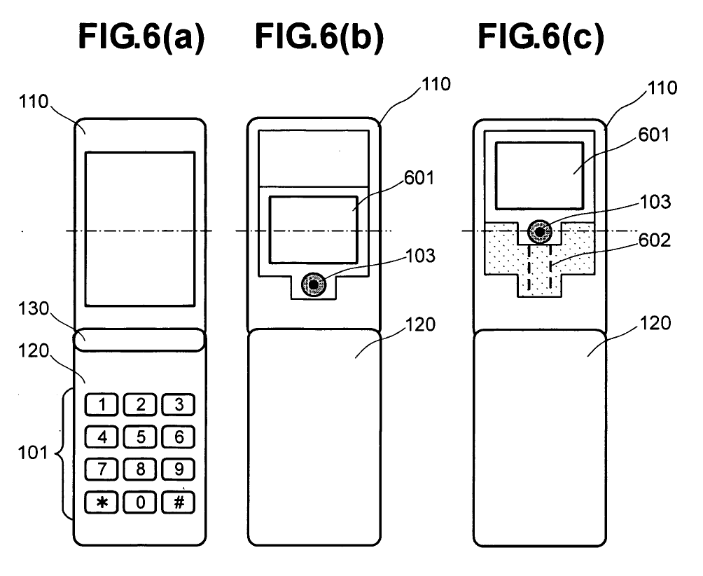

FIG. 6 (consisting of 6(a) to 6(c)) is an external view of a cellular phone.

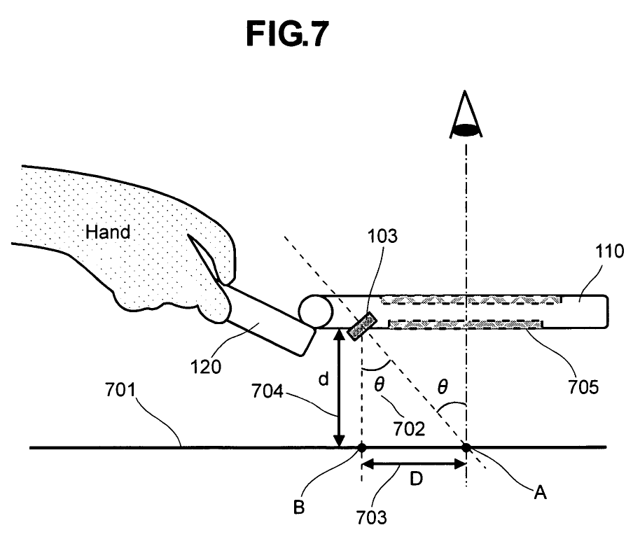

FIG. 7 is an illustration showing the positional relationship among the user's eye, the camera and the display during an exemplary OCR operation.

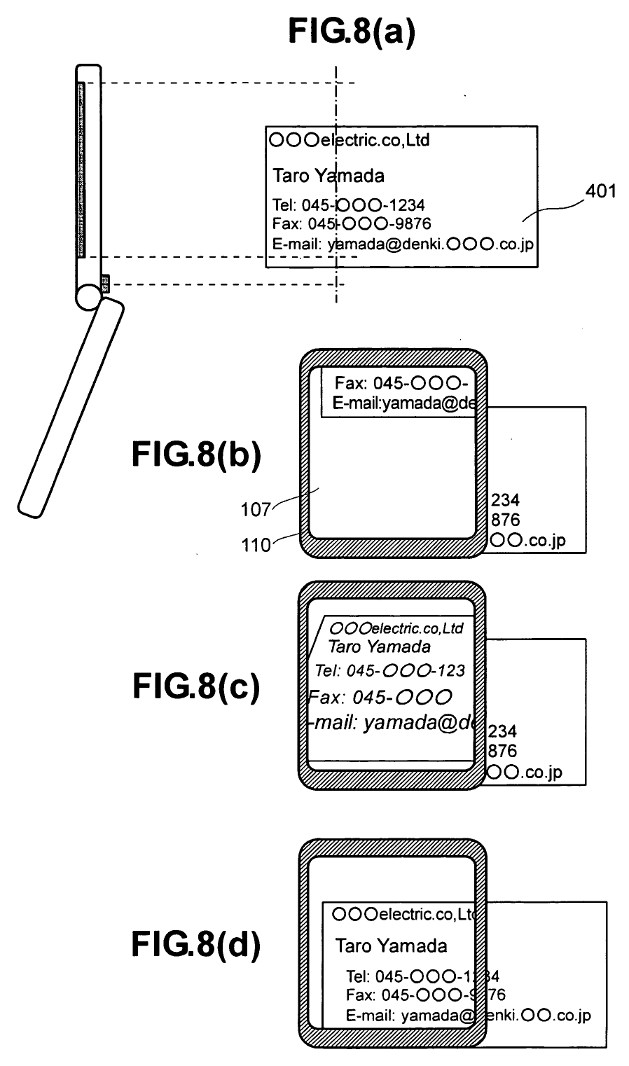

FIG. 8 (consisting of 8(a) to 8(d)) is an example of display screen outputs of the cellular phone.

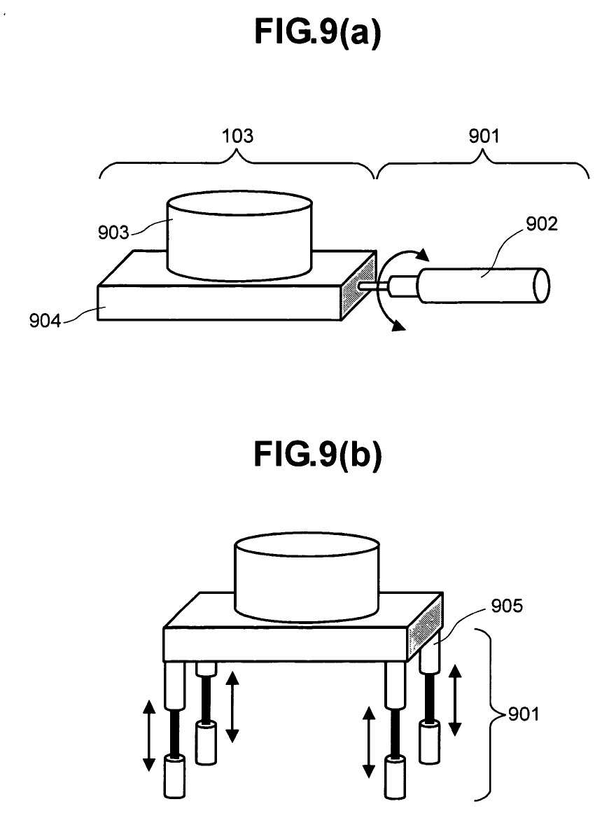

FIG. 9 (consisting of 9(a) to 9(b)) is an illustration showing an angle correction part and a rotation drive part.

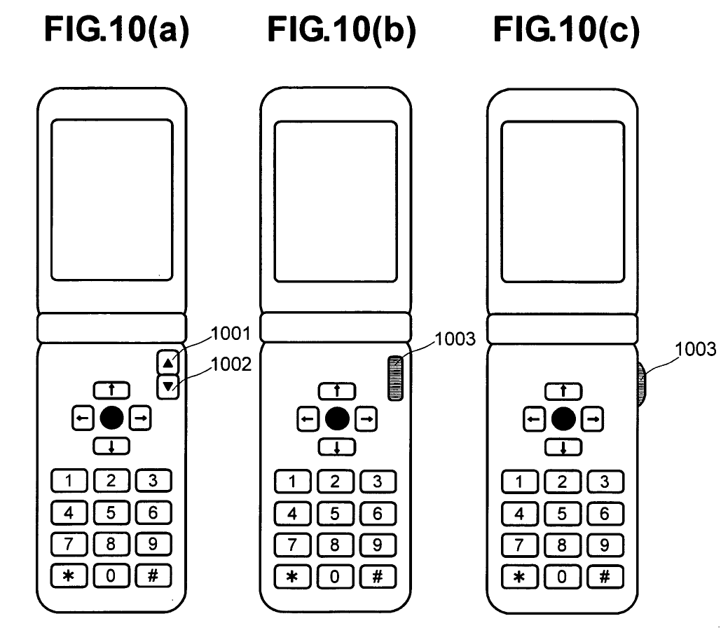

FIG. 10 (consisting of 10(a) to 10(c)) is an external view of a cellular phone.

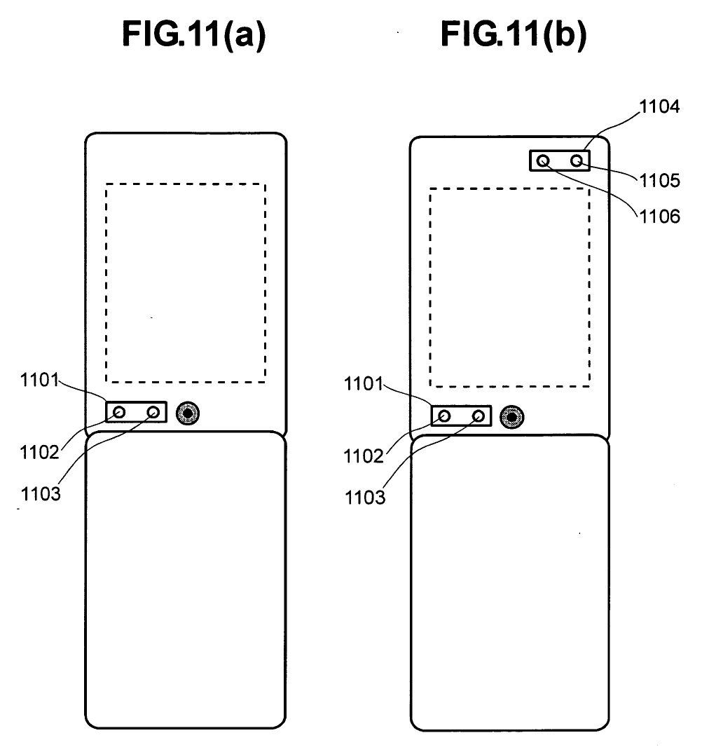

FIG. 11 (consisting of 11(a) to 11(b)) is an external view of a cellular phone.

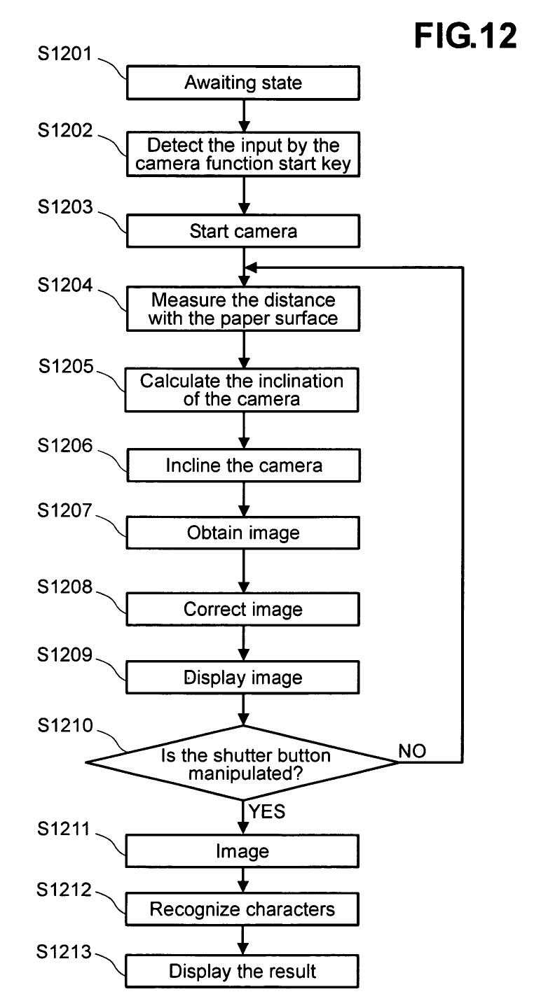

FIG. 12 is a flowchart showing the operation of the information processing apparatus.

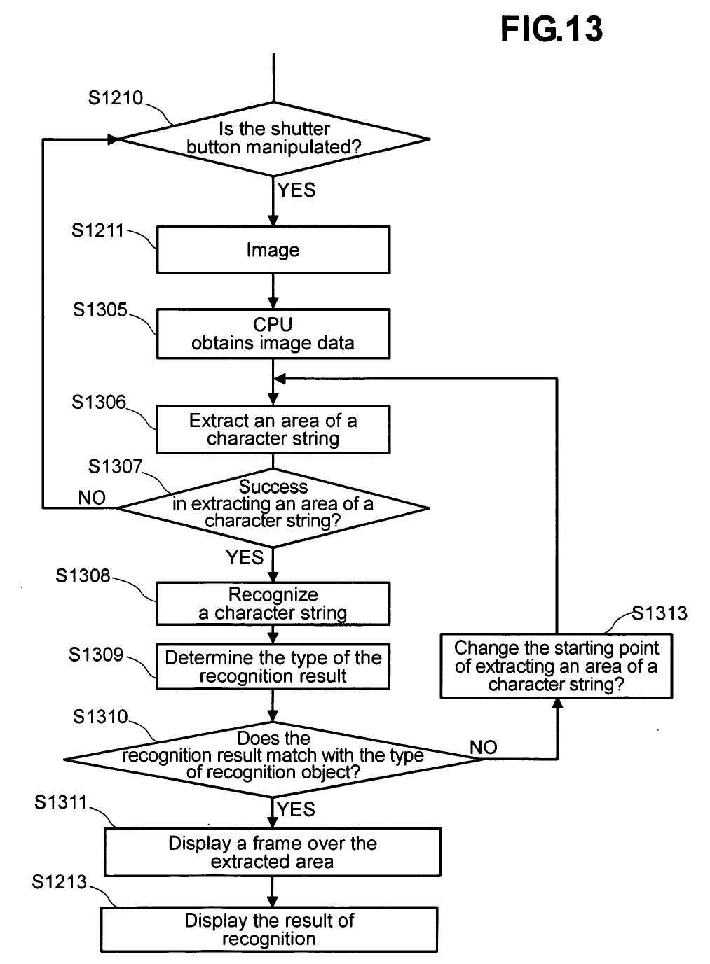

FIG. 13 is a flowchart showing the character recognition operation of the information processing apparatus.

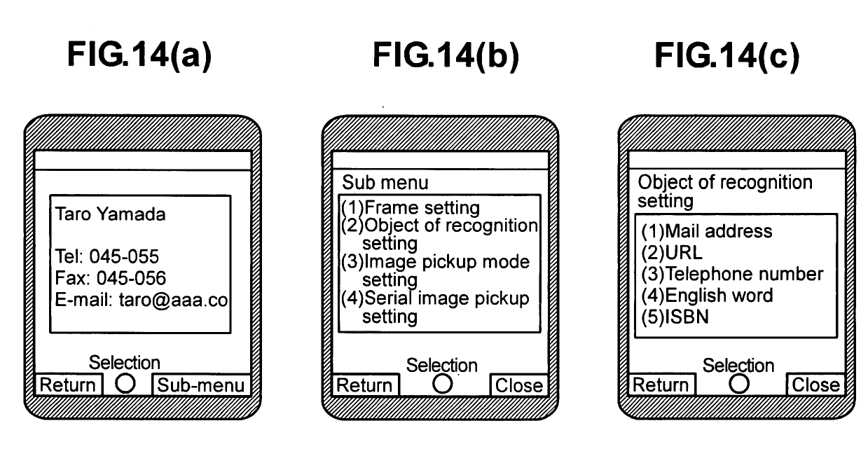

FIG. 14 (consisting of 14(a) to 14(c)) is an example of display screen for selecting the type of recognition object in the information processing apparatus.

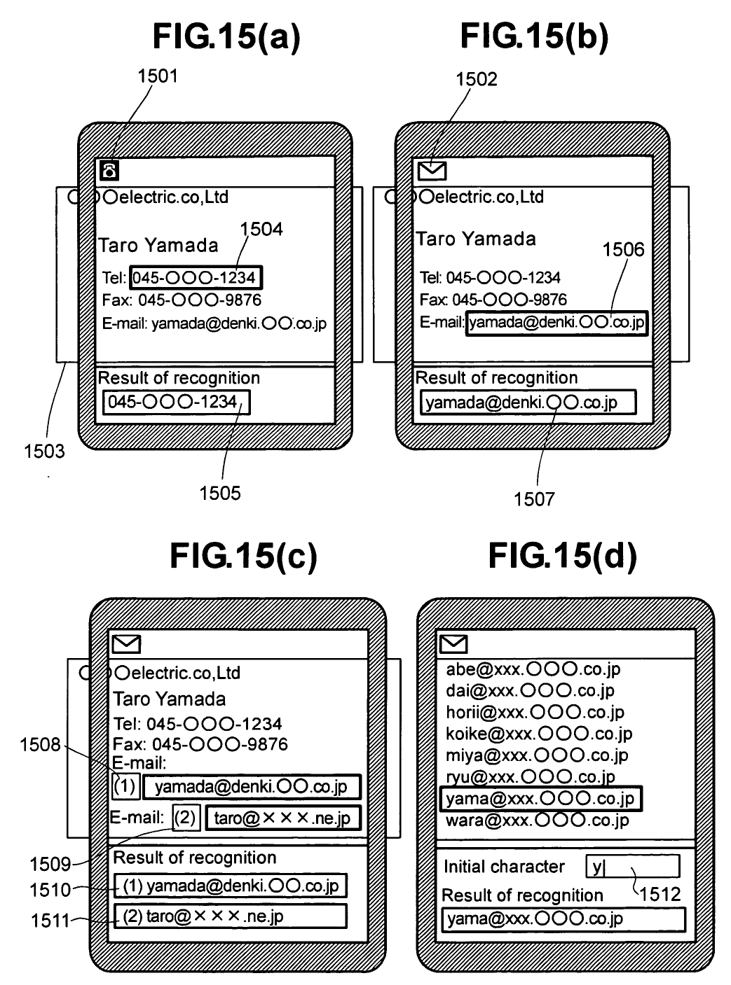

FIG. 15 (consisting of 15(a) to 15(d)) is an example of display screen wherein a business card is monitoredt.

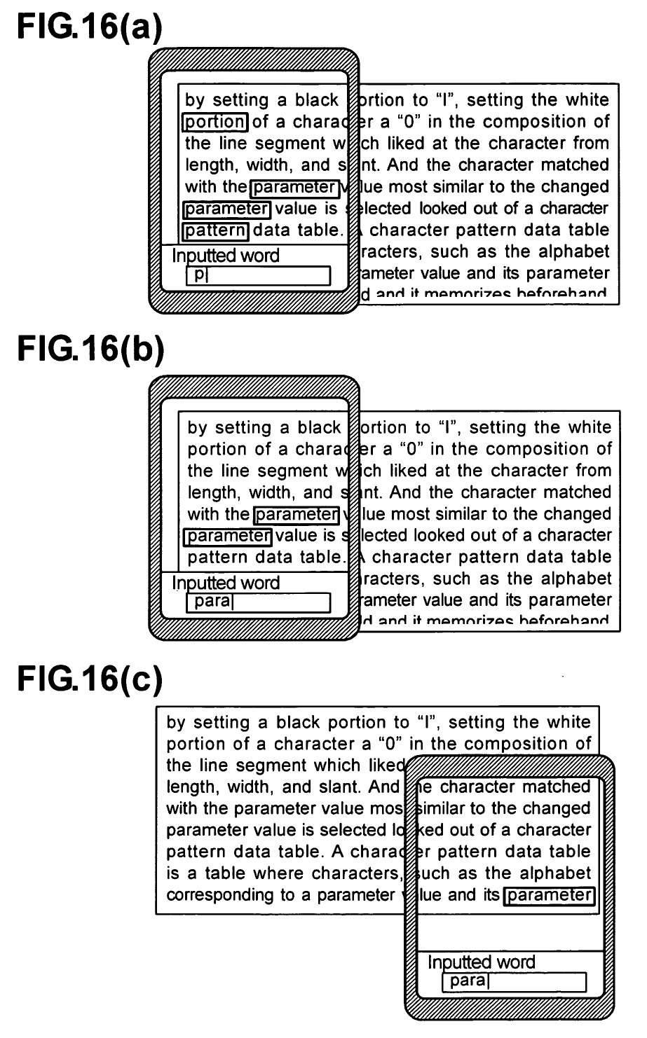

FIG. 16 (consisting of 16(a) to 16(c)) is an example of display screen of the information processing apparatus.

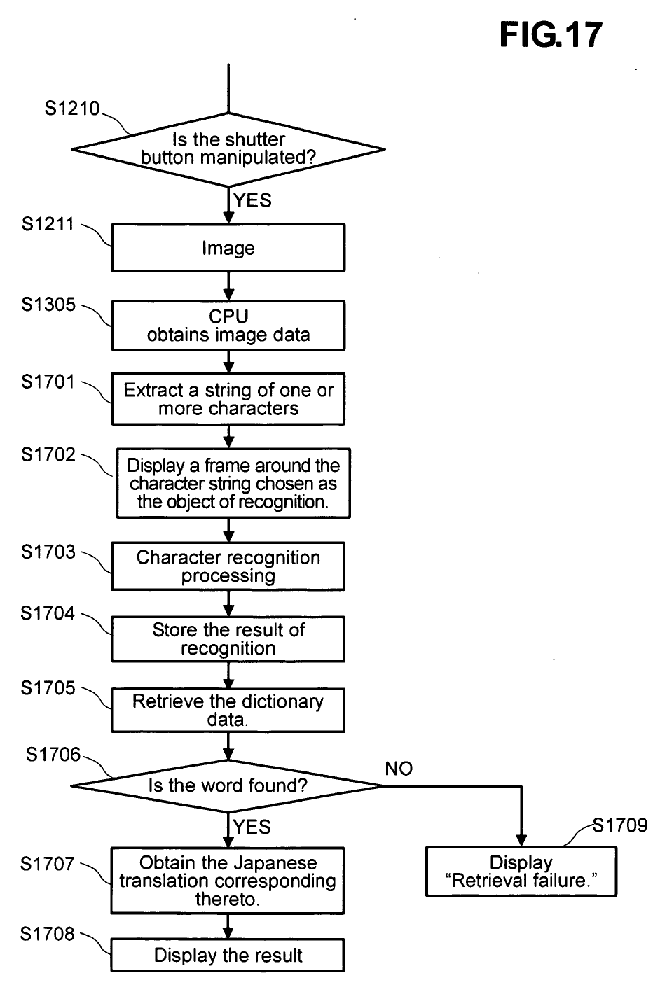

FIG. 17 is a flowchart showing the process of the information processing apparatus.

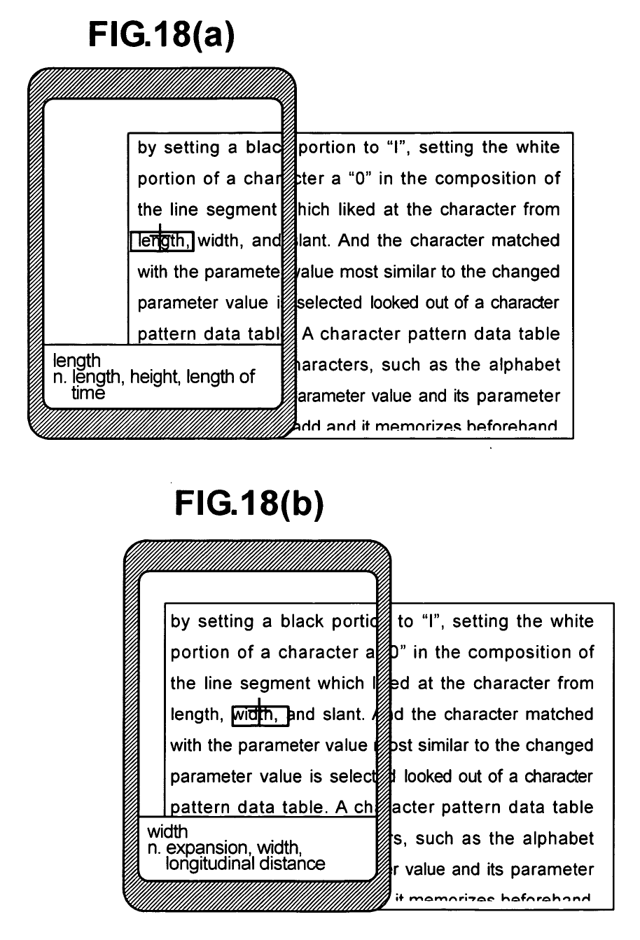

FIG. 18 (consisting of 18(a) to 18(b)) is an example of display screen of the information processing apparatus.

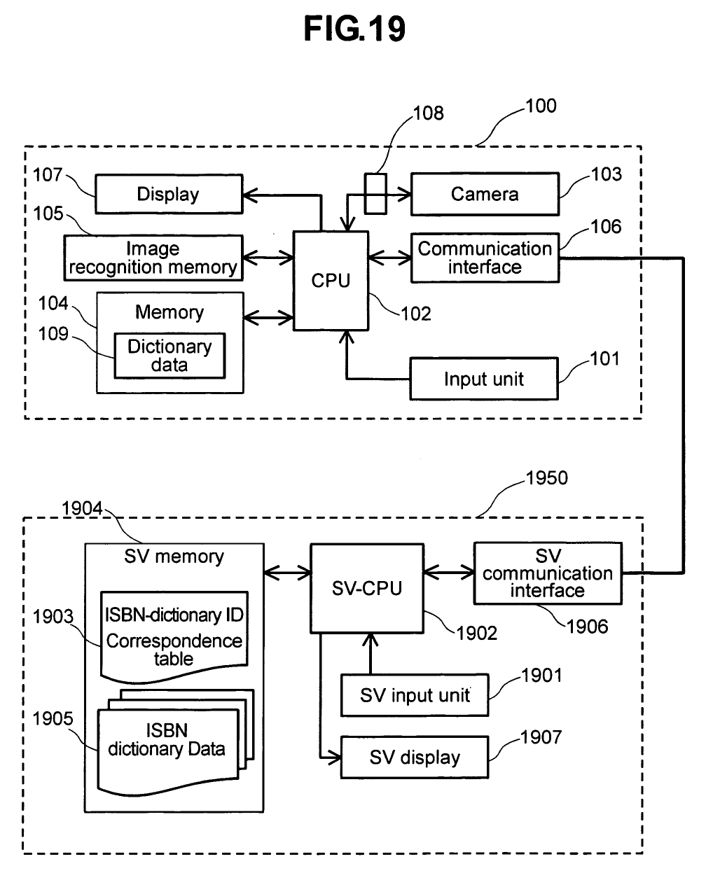

FIG. 19 is a schematic diagram showing an example of system for exploring definitions of words.

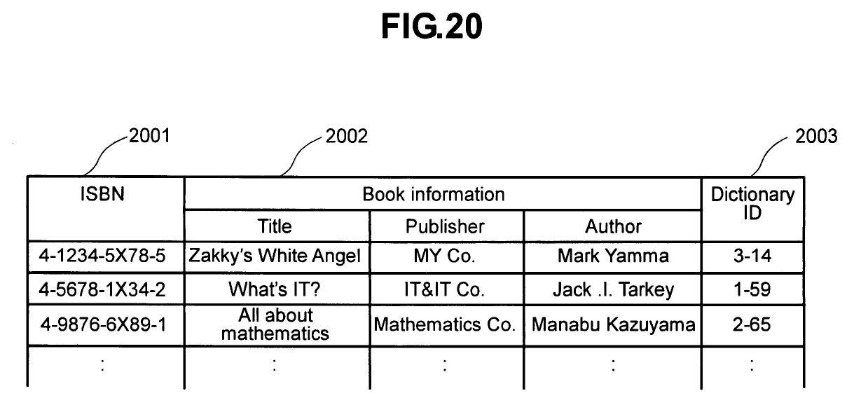

FIG. 20 shows an example of the contents of the ISBN-dictionary ID correspondence table.

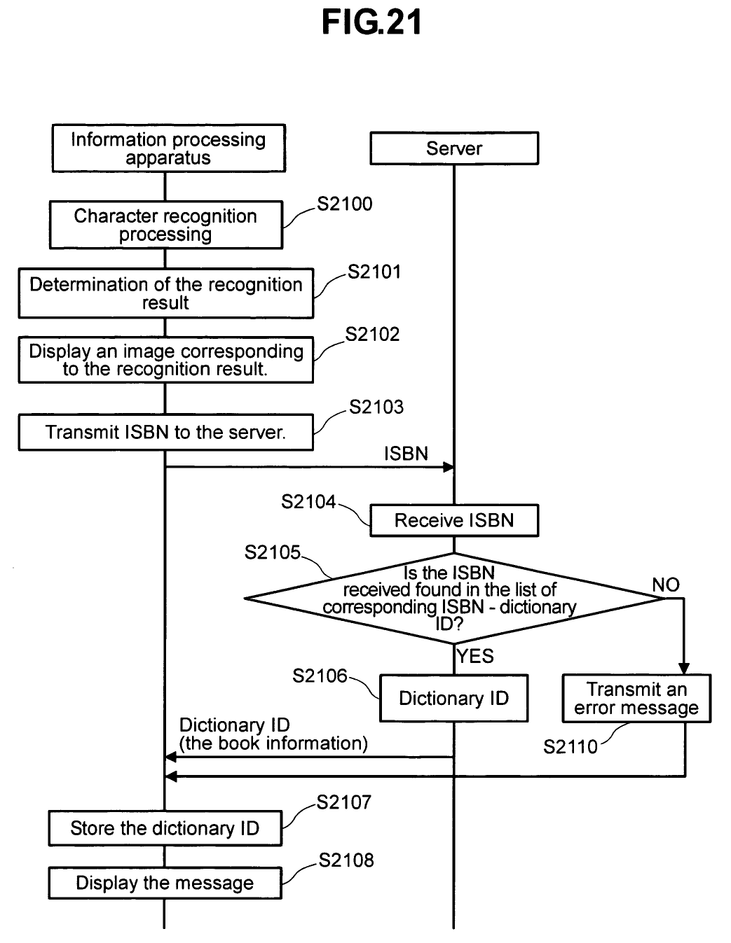

FIG. 21 is a flowchart showing the process of register the dictionary IDs of the ISBN specific dictionary.

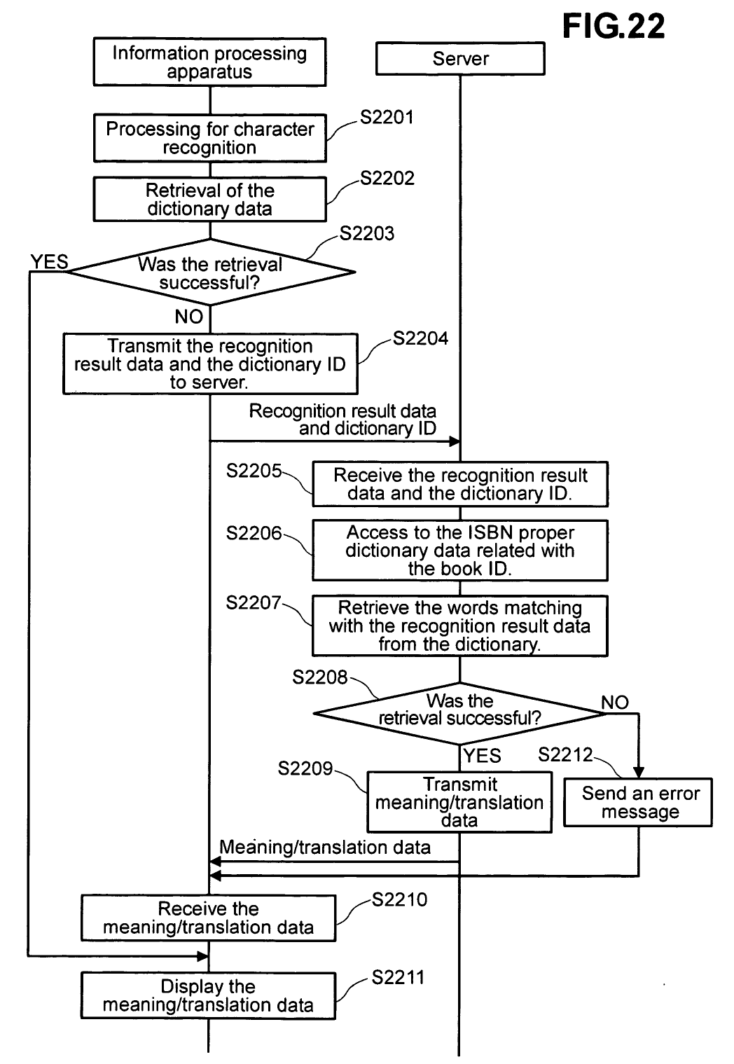

FIG. 22 is a flowchart showing the processing to display the meaning/translation of the words.

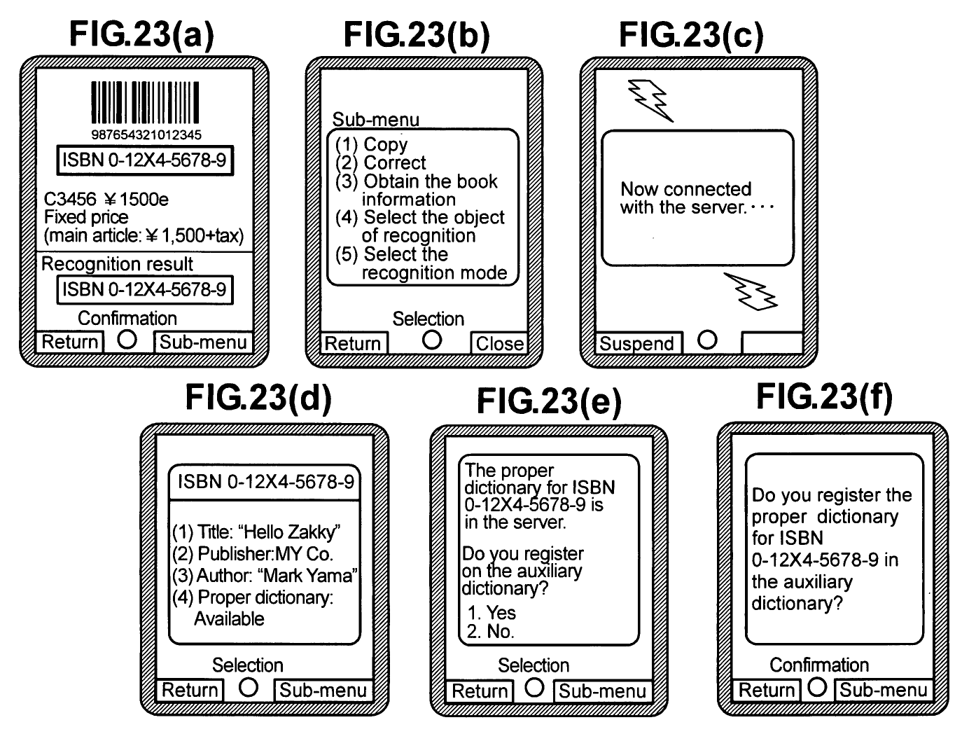

FIG. 23 (consisting of 23(a) to 23(f)) is an example of display screen of the information processing apparatus.

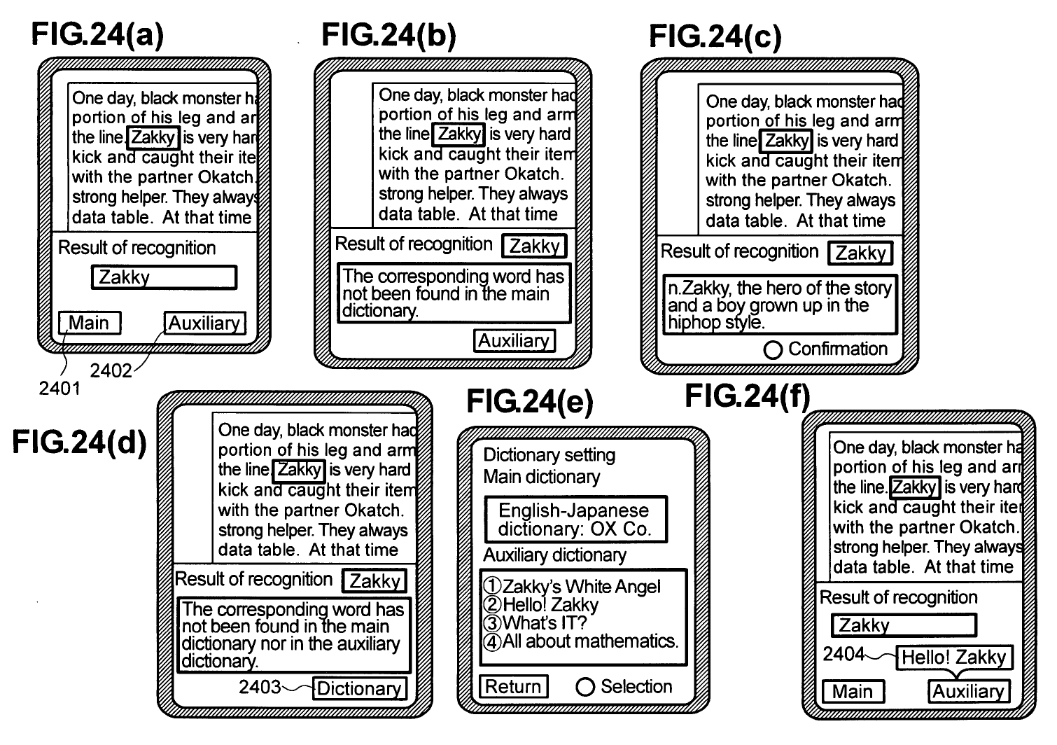

FIG. 24 (consisting of 24(a) to 24(f)) is an example of display screen displaying the meaning/translation data of words.

### DETAILED DESCRIPTION

The various examples disclosed herein relate to information processing apparatuses with a camera positioned to make a displayed image of a object consistent with a view of the object by a user, methods and software products for improving consistency between a displayed image of a object and a view of the object by the user. In the examples, the recognition procedures are also explained.

The examples will be described hereinafter with reference to drawings. In the following drawings, identical codes will be used for identical components.

FIG. 1 is a block diagram of an information processing apparatus.

An input unit 101 comprises a keyboard that has a plurality of keys including a shutter button, a power button, and numerical keys. A user operates the input unit 101 to enter information such as a telephone number, an email address, a power supply ON/OFF command, and an image-taking command requesting a camera 103 to take a picture or the like. The input unit 101 may comprise a touch-sensitive panel type allowing a user to enter information or a directive by touching the screen of a display using a pen or his/her finger. Otherwise, a voice recognition unit may be included in order to adopt a voice recognition-based entry method.

CPU (central processing unit) 102 controls components of the information processing apparatus by execution of a program stored in a memory 104, and controls various parts in response to, for example, an input from the input unit 101.

Camera 103 converts an image of human, scenery, characters and other subjects into picture information. The picture information is inputted into the CPU 102 via a picture interface 108. The image may be converted into any form of picture information as long as the picture information can be handled by the CPU 102. In this example, the camera 103 is built in the information processing apparatus. This invention is not limited to this example. The camera may be external and attached to the information processing apparatus through the picture interface 108

The CPU controls the display of picture information on a display 107. The user chooses an image that he or she wants to take a picture by monitoring the picture information outputted on the display 107. At this time, the display 107 is used as a viewfinder. The user gives an instruction on taking a picture by, for example, depressing an operating key allocated as a shutter key (hereinafter referred to as “shutter key”). As the shutter key is depressed, the picture information output by the camera 103 is stored at the memory 104. The memory 104 is constituted by, for example, a ROM (Read Only Memory) or a RAM (Random Access Memory). The memory 104 is also used for storing video and/or audio data and software to be executed by the CPU 102 in order to carry out operations or the like.

A picture recognition memory 105 stores a software program to be executed for an OCR (Optical Character Recognition) function by the CPU 102. The OCR function is a function to recognize a character including a letter, a sign, a symbol, a mark, a number, and identification information or the like included in a picture.

Examples of the identification information are a home page address, a email address, a post address, a phone number, geographical information, a data number including a publish number and an ISBN (International Standard Number) or the like. The scope of the identification information is not limited to these examples. The identification information may be any information as long as the information can be used for identifying a person, a place, a thing or the like.

The recognition of characters comprises the steps of identifying a place in an image that includes characters from a picture taken by the camera 103, dividing the image data for the portion containing characters into predetermined portions, converting each of the data for the portions into a parameter value and determining what information is included in each of the portions on the basis of the parameter value.

As an example, recognition of characters ‘abc’ included in a picture is explained. First of all, the place at which the characters ‘abc’ is included in the picture is identified. Then, the image data for the portion containing characters ‘abc’ are split into portions containing characters ‘a’, ‘b’ and ‘c’. The data for portions contains characters ‘a’, ‘b’ and ‘c’ are converted into respective parameter values. Examples of the parameter-value digit are ‘0’ representing a white-color portion of a character and ‘1’ representing a black-color portion of a character. For each portion, a character most resembling the parameter value is selected among characters included in character pattern data. The character pattern data is data associating each parameter value with a character such as an alphabetical character corresponding to the parameter value. The character pattern data may be stored in the memory 104 in advance or downloaded or installed by the user later.

In this example, a memory dedicated for a picture recogntition software is provided as the picture recognition memory 105. As an alternative, picture-processing software may be embedded in the CPU 102 or the memory 104 to provide the CPU 102 with an OCR function. By embedding the picture-processing software in the CPU 102 or the memory 104, the number of components may be reduced and the manufacturing cost and the like may also be decreased as well.

In this example, in order to shrink the circuit scale, the CPU 102 executes the OCR function. However, the configuration of the present invention is not limited to this example. For example, a dedicated processor can be used for implementing the OCR function.

Specifying an area to be recognized is required before the recognition. For example, a user takes a mark such as “+” , ‘?’, ‘?’ or the like shown in the center of the display 107 onto a position above characters. The area starting with a space information near the mark and ending with the following space information is specified as a recognition area.

Alternatively, the user operates the input unit 101 to move a cursor on the display 107 to specify the recognition area. And it is possible to make an arrangement whereby, when there are two or more methods to decide recognition objects, multiple methods can be chosen at the same time. If the area selection processing is carried out during reproduction of a moving picture, the reproduction mode is switched to a frame-feeding mode. A recognition area is selected from still pictures displayed in the frame-feeding mode.

And by adopting a structure wherein a “formal decision” is made after an object provisionally decided as a case of “provisional decision” before deciding the recognition object is found to be a correct object, it will be possible to easily change the recognition objects when an error is found in the specification of recognition object at the stage of provisional decision.

The display 107 is constituted by a LCD (Liquid Crystal Display), an organic EL (Electroluminescence) or the like. The display 107 displays an image output by the camera 103 and a result of recognition. In addition, the display 107 displays information such as the state of power source, radio field intensity, the remaining battery amount, the state of connection with a server, presence of unread e-mails, inputted telephone numbers, mail addressees, a text of transmitted e-mail, motion pictures and still pictures, calling party's telephone number at the time of call reception, a text of received mail, and data received from the Internet.

A communication interface 106 performs communication with a server or a host computer of an information provider, or with any other device, via a network. It is also possible to provide a plurality of communication interfaces instead of using only one as shown in FIG. 1. In this case, a user may use a plurality of communication methods such as CDMA, EV-DO, wireless LAN, etc.

The following description explains a case in which there are two kinds of image-taking mode, i.e., a recognition mode of taking a picture to be recognized and an ordinary image-taking mode of taking a picture of a human being and scenery or the like as an ordinary camera function. However, the scope of the present invention is not limited to these modes. The CPU 102 determines whether the apparatus is operating in the ordinary image-taking mode or the recognition mode by using a mode determination flag. The mode determination flag is handled as a variable in a program of the software stored in the memory 104. The value of the mode determination flag for the recognition mode is different from the value for the ordinary image-taking mode.

FIG. 2 (a) is an exemplary front view of a cellular phone, FIG. 2 (b) is an exemplary side view of the cellular phone, and FIG. 2 (c) is an exemplary rear view of the cellular phone. The cellular phone includes a housing 110 containing a display 107 and an camera 103, and a housing 120 containing an input unit 101.Both of the housings are linked together by a hinge 130, the structure being collapsible.

The camera 103 is disposed in the back side (referred hereinafter to as “the back surface”) opposite to the surface in which the display 107 is disposed (referred hereinafter to as “the front surface”). The position of camera 103 is near the point at the intersection of the back surface with a line drawn from near the center of the display 107 towards the normal line of the display. Hereinafter, The point is named to “the rear central corresponding point.” Here, the center of the display 107 means the visual center of the display 107.

For example, if the display 107 is rectangular, the intersection of diagonal lines will be the center without regard to the deviation of its mass distribution and therefore will be the “visual center” of the display 107.

It needs not be precisely the center of the display. For example, an error in the range of several millimeters (mm) can be tolerated provided that little or no feeling of inconsistency arises due to a positional gap between the case of looking at a paper surface with the eyes and the case of looking at the image information of a paper surface acquired by the camera 103.

By locating the camera 103 near the rear central corresponding point, the character on the paper surface appears on the display 107 and the character shown in the display 107 looks like it is at more or less the same position as would be seen directly by the user. Consistency between a displayed image of a object and a view of the object by the user may be improved. Therefore, the user will be able to choose easily a character string that he or she wants to recognize at the time of character recognition and the system will be easy to operate and convenient.

It is preferable that the camera 103 would be constructed avoiding any protrusion from the back side. This is due to the fact that the users may carry their cellular phone in a collapsed state, and they risk damage by colliding with other objects, for example a baggage or a desk.

The cellular phone shown in FIG. 2 has the main display 107 only. However, this invention is not limited to the example. The apparatus may have a sub-display on the back of the housing 110 for displaying various items. It would be very convenient because it may be possible to confirm the reception and arrival of an e-mail, time or any other items while the apparatus is collapsed.

FIG. 3 (a) is an illustration showing the case wherein the sub-display 301 is arranged above the camera 103, in other words on the other side of the hinge 130 as seen from the camera 103. Obviously, it is possible to adopt a structure of disposing the sub-display 301 below the camera 103, in other words, in the space between the hinge 130 and the camera 103.

FIG. 3 (b) is an illustration showing the arrangement of a sub-display 301 above the camera 103 and another sub-display 302 below the camera 103. This arrangement is adopted by taking into account the problem that the arrangement of the camera 103 near the rear central corresponding point as described above limits the dimensions of the sub-display 301. Thus, the existence of a plurality of sub-displays on the back side allows to secure a sufficient display area wherein various data can be viewed even while the cellular phone is collapsed. In addition, if the role of each sub-display is specified for displaying the contents thereof, it will be more convenient for the user.

For example, in the case of listening to MP3, MIDI files and other music files while the cellular phone is collapsed, it will be easier for the user to operate if a sub-display is allocated the function of displaying the artist name and another sub-display is given that of displaying the lyric and other items. In this case, it is needless to say that the cellular phone is provided with a speaker or other audio data output parts (not illustrated) for listening to music.

Furthermore, it is preferable to adopt a construction that allows the user to select which sub-display he or she will use by manipulating the input unit 101. In this case, when the user gives an instruction on the selection of the sub-display to be used, a sub-display selection signal is inputted into the CPU 102. The CPU 102 determines the sub-display to which power will be supplied based on the sub-display selection signal.

In this way, the user can select only the sub-display to be used when there are a plurality of sub-displays. Therefore, it is not necessary to supply power to all of the plurality of the sub-displays. This arrangement may contribute to the economy of power consumption and also to the improvement of operability.

The display 301 and the display 302 may be located on the right and left side of the camera 103. And the number of sub-displays maybe two or more. Alternatively, the sub-display 303 can be arranged around the camera 103 as shown in FIG. 3 (c). FIG. 4(a) is an exemplary front view of a cellular phone and FIG. 4(b) is an exemplary rear view of the cellular phone. An OCR screen 402 is a screen to be used to display an image output from the camera 103 in the recognition mode. The OCR screen 402 is displayed on the display 107 based on an OCR screen area data stored in the memory 104. The OCR screen area data is a data indicating a location of the display 107 in which the OCR screen 402 should be displayed. When the user selects the recognition mode, the CPU 102 displays the OCR screen 402 on the display 107. The OCR screen 402 is distinguished from another part of screen 401 on the display 107 by putting a box or the like around the OCR screen 402.The CPU 102 displays picture information outputted by the camera 103 in the OCR screen 402.

In this example, the camera 103 is disposed near the point at the intersection of the normal line drawn from the center of the OCR screen 402 towards the back surface opposite to the OCR screen 402 with the back surface. Here, for example, the disposition of the OCR dedicated screen 402 below the display area 401 as shown in FIG. 4(a) results in the disposition of the camera 103 on the back side in the lower part of the screen, in other words closer to the hinge part. Therefore, the space required to provide a sub-display 403 on the back side will be larger as compared with the example shown in FIG. 3(a).

Accordingly, it is possible not only to recognize easily characters by improving consistency between a displayed image of a object and an view of the object by the user as mentioned above, but also to increase the area of the sub-display. And as a result, it will be easier for the user to operate the cellular phone when the phone is closed.

In FIG. 4, the OCR screen 402 and the camera 103 are disposed in the lower part of the housing 110. The invention is not limited to this example. They may be disposed in the upper part of the housing 110.

It is also possible to display information related to other functions on a screen other than the OCR screen 402 within the display screen 401.

For example, when an e-mail address contained in a business card is displayed on the OCR screen 402, an address book stored in the memory 104 is displayed in an area other than the OCR screen 402 within the display screen 401. It is possible to make an arrangement that the e-mail address can be stored in the address book through a given operation.

This set-up enables the user to register quickly an e-mail address in the address book without giving any specific instruction on the matter, and makes the whole system easier to use. In addition to this, when the recognition object is URL information, it is possible also to display the contents of the URL in an area other than the OCR screen 402 within the display screen 401.

In this example, the cellular phone is collapsible. It is possible to apply the present invention to an information processing apparatus of other forms. For example, as shown in FIG. 5, a housing 510 containing the main display and another housing 520 containing the main operation part are rotatably linked in an approximately horizontal direction through a linkage part 530 will be described below. Hereinafter, this type of the appratus is called rotatable type.

FIG. 5 (a) shows the closed state of the rotatable type cellular phone, FIG. 5 (b) shows the open state thereof and FIG. 5 (c) shows the back side of FIG. 5 (b).

As shown in FIG. 5 (c), the camera 501 is disposed near the point corresponding to the central of the display screed 504 on a housing 510. The camera 502 is positioned on a housing 520, near the point corresponding to the central of the display 504 shown in FIG. 5 (c). This improves consistency between a displayed image of a object and an view of the object by the user. Some positional errors may be tolerated as long as the user can easily select the character that he or she wishes to have recognized. By this set-up, when the user recognizes characters while the rotatable type cellular phone is closed or open, he or she can easily select the character because of the substantial consistency between a displayed image of an object and a view of the object by the user. Therefore the whole phone may be easy to operate and convenient.

The use of an input key 503 enables to operate the cellular phone even when it is closed as shown in FIG. 5 (a). And this is convenient.

FIG. 6(a), (b) and (c) show another example of a cellular phone. In FIG. 6, the camera 103 and the sub-display 601 are integrated, and even when the camera 103 moves, the relative distance between them remains almost the same. Normally, the sub-display 601 is positioned approximately near the center of the back side as shown in FIG. 6 (b). In the recognition mode, the camera 103 is moved to a position corresponding to the center of the display 107 as shown in FIG. 6 (c).

In this case, a travelling groove 602 is formed on the back surface of the housing 110 to allow the user to move the camera 103 .

The cellular phone may includes a circuit for input an OCR function activation signal to the CPU 102 near the center of the housing 110 and a switch near the camera 103. When the user move the camera 103 to the position near the center of the housing 110 shown in FIG. 6 (c), the switch contacts with the circuit. When the switch is in contact with the circuit, the CPU 102 operates to start the recognition mode. the picture information output from the camera 103 is displayed on the main display 107.

In this example, the sub-display 601 is disposed at a position near the center of the back surface of the housing 110, said the user may look at the sub-display 601 easily. In addition, since the transfer of the camera 103 automatically causes the recognition mode to start, it becomes possible to save the required operation.

In the above description, the integrated structure of the camera 103 and the sub-display 601 has been described. However, they need not be integrated. The camera 103 and the display 601 may move separately.

The cellular phones shown in FIG. 2-6 are examples of information processing apparatuses. Application of the concepts are not limited to the cellular phone. The concepts may be used in not only a cellular phone but also other information processing apparatuses such as a PHS, a PDA and a laptop or handheld personal computer. Other examples of the information processing apparatus may include extra elements such as a speaker, a microphone, a coder, and a decoder.

And now, the second method for improving consistency between a displayed image of an object and a view of the object by the user will be described. The adoption of a structure of having the camera 103 at a position near the rear central corresponding point as mentioned above may result in the housing 110 getting thicker because of the display 107 and the camera 103. This in turn may make the whole phone somewhat difficult to carry and less aesthetically refined from the viewpoint of design. And there is a problem that the dimensions of the sub-display maybe limited depending on the position of the camera 103.

Accordingly, the case of disposing the camera 103 at a position shifted from near the rear central corresponding point, for example at a position near the hinge part 130 on the back side of the housing 110 so that it may not overlap with the display 107 will be described. In this case also, the construction designed to enable the user to select the object of recognition improving consistency between a displayed image of a object and an view of the object by the user will be described hereinafter.

FIG. 7 is an illustration showing the positional relationship among the user's eye, the camera 103 and the display 107 of a cellular phone during an exemplary OCR operation, and the surface 701 of a business card and a magazine or the like. In this example, the information processing apparatus includes a sub-display 705. However, the present embodiment is not limited to this example, the cellular phone may not have the sub display 705.

In order to make the position of characters on the paper surface and the position of characters on the display 107 approximately in the same way at the time of recognition, the camera 103 will be disposed obliquely so that it may face a position near the center of the intersection between the normal line of the display 107 and the paper surface 701. In other words, the camera 103 is inclined by an inclination angle θ 702. This inclination angle θ 702 is determined based on the distance D 703 and the distance d 704. The distance D 703 referred here is the distance between the point A where the normal line drawn from the center of the display 107 crosses the paper surface 701 and the point B where the direct line drawn in parallel with the normal line from a position near the center of the camera 103 crosses the paper surface 701. The distance d 704 is the distance between a point near the center of the camera 103 and the paper surface 701. The inclination angle θ 702 will be calculated based on the values of the distance D 703 and the distance d 704. Appropriate values of distance d 704 and the distance D 703 may be set previously at the time of design based on the focal distance of the camera 103, for example, in a range of 2-4 cm for the distance d 704 and also in a range of 2-4 cm for the distance D 703. It is preferable to inform the user of the appropriate values.

In the meanwhile, it is preferable that the default value of the distance d 704 would be set by assuming for example the question of how far the user should be separated from the paper surface to be able to recognize easily characters and other points for actual recognition of characters. And the default value of the distance D703 is determined by dimensions of the camera 103 and the display.

FIG. 8(a) is an illustration for explanation of the recognition situation. FIG. 8 (b) is an example of displaying the image information before the camera 103 is inclined. Here, as the camera 103 is positioned in the lower part (on the hinge side), only the lower part of a name card is displayed.

FIG. 8 (c) is an example of a display screen in the case where the inclination of the camera 103 is adjusted from the state shown in FIG. 8 (b). The characters displayed in the lower part of the display 107 are large, while the characters displayed in the upper part are small, and the characters are displayed obliquely. The characters displayed on the display 107 are distorted obliquely because the characters written on paper are photographed obliquely and constitute a display screen difficult to discern. As long as this condition remains unchanged, it will be difficult for the user to select the characters he or she may wish to have recognized.

Accordingly, the CPU 102 corrects the image displayed obliquely so that it may be displayed flatly. For this correction, for example, the keystone distortion correction method may be applied to correct an oblique image to a flat one. However, other correction methods may be used.

The screen examples are shown in FIG. 8 (d). As a result of the correction of distortion resulting from the inclination of the camera 103 in relation to the housing surface, the characters appearing on the paper surface and the characters displayed on the display 107 look almost the same with regards to their position and size. Thus, the characters to be recognized can be easily selected at the time of recognition of characters and the operability of the whole system improves.

In a cellular phone wherein the camera 103 is inclined obliquely as described above, this is effective for recognizing characters. However, in the ordinary image-taking mode, the object of image pickup at the target point of sight of the user and that displayed on the display 107 may be quite different because of the inclination of the camera 107 by an angle θ 702. For example, when the user wants to take picture of the face of a man, the leg of the man may be displayed on the display. In such a case, it will be difficult to pickup image of the face of any man or woman.

Accordingly, the case of making the inclination of the camera 103 variable will be described below. In this example, the angle θ 702 is changed based on the image-taking mode.

An angle correction part for correcting the inclination of the camera is provided beside the camera 103. This will be explained with reference to FIG. 9.

As shown in FIG. 9 (a), the angle correction part 901 has a rotation drive part 902. And as the rotation of this rotation drive part 902 is transmitted to the camera 103, the camera 103 rotates. It should be noted that here the module-type camera 103 consists of an image lens 903 and image pickup circuit 904 and the rotation drive part 902 is connected with the image pickup circuit. However, this configuration is not limitative.

And now the operation of correcting the inclination of the camera 103 will be described. When the user selects one of the image-taking modes by using the input unit 101, the CPU determines whether the selected mode is the recognition mode or the ordinary image-taking mode.

In the recognition mode, the CPU 102 transmits the angle correction signal that had been previously stored in the memory 104 to the angle correction part 901. The angle correction part 901 having received the angle correction signal rotates by the revolutions corresponding to the angle correction signal. As a result, the camera 103 rotates by the given angle.

When the recognition mode ends, the CPU 102 again transmits an angle correction signal to the angle correction part 901 to restore the camera 103 that had rotated to the original inclination. Here, the angle correction signal to be transmitted contains data indicating a reverse rotation to the angle correction signal that had been sent previously or data necessary to restore the camera to the original inclination. And the angle correction part 901 having received this angle correction signal rotates the camera 103 to the original inclination in response to the angle correction signal.

On the other hand, when the user selects the ordinary image-taking mode, the inclination of the camera 103 is not changed.

By making the camera 103 variable only during the recognition mode as described above, it is possible to prevent unnecessary rotation of the camera 103 during the ordinary image-taking mode. As a result, it is possible to clear the problem of a substantial difference between the object of image pickup at the target point of the sight of the user and that displayed at the display 107 in the ordinary image-taking mode.

This automatic restoration of the camera 103 to the original inclination may save the manual operation of restoring the camera 103 to the original state, and therefore improves the operability of the apparatus. In addition, when the camera is inclined, a part of the camera 103 sometimes protrudes from the housing surface. And by automatically restoring the inclination of the camera 103 to the original position, it is possible to prevent the camera 103 from being damaged due to the protrusion.

In addition, by adopting a system wherein the inclination of the camera 103 cannot be changed only when the current mode is judged to be the ordinary image-taking mode a notice that the current mode is the ordinary image-taking mode is displayed, the user can easily understand the reason why the camera 103 is not variable (the current mode is not “the recognition mode.”)

In this example, the case wherein the inclination of the camera 103 can be changed only during the recognition mode was considered. However, the inclination of the camera 103 may be made variable also during the ordinary image-taking mode. In this case, when the ordinary image-taking mode is deactivated, the camera 103 is restored to the original state And the angle correction part 901 may comprise actuators 905 connected with the camera 103 as shown in FIG. 9 (b). Here, the case of four actuators 905 connected with the camera 103 is considered, and in this case, the inclination of the camera 103 is changed by the movement of each of the four actuators. By adopting such a structure, the camera 103 can be inclined in various ways, enabling the user to make fine micro corrections and improve the operability of the whole apparatus.

Furthermore, as shown in FIG. 10, it is possible to provide an upward button 1001, a downward button 1002 or other buttons exclusively designed for changing the inclination of the camera 103. The upward button 1001 is a button for increasing the inclination angle of the camera 103. When the user depresses this button, an angle increase instruction signal is outputted to the angle correction part 901 through the CPU 102, and the angle correction part having received this signal corrects the inclination of the camera 103 in response to the angle increase instruction signal. When the user depresses the downward button 1002, a similar correction will be made.

As the user himself or herself can correct the inclination of the camera 103 in this way, the user can orient the camera 103 in the direction easiest for him or her to look at, improving the operability of the whole apparatus.

And it is also possible to adopt a dial system such as an angle correction dial 1003 in place of an upward button 1001 or a downward button 1002 (see FIGS. 10(b) and 10(c).) By adopting such a system, the angle of inclination can be finely corrected.

In the meanwhile, the direction of inclination is not limited to around the hinge shaft (the center shaft of the hinge part), but it is possible to envisage inclination in other directions. In such a case, an operation key adapted to a 360° rotation (for example: a joy stick) may be used. By adopting such an arrangement, it will be possible to search words chosen as the recognition objects written on paper while keeping the hand holding the cellular phone immobile. And thus the whole system will be easier to use and more user-friendly.

FIGS. 11(a) is an external view of a cellular phone. A distance sensor 1101 measures a distance between the object in front of the sensor 1101 and the sensor 1101. The distance sensor 1101 measures the distance by measuring the time required for the infrared ray emitted from an light projection part 1102 to travel to an object in front of the sensor and return to the light reception part 1103 of the sensor 1101. Here, an infrared ray distance sensor 1101 is used. However, any distance sensor using ultrasonic waves or other means may be used. The sensor needs not be one capable of measuring precise distance, and may be a sensor capable of determining whether there is any object within a certain rough distance from the sensor.

It is preferable that the distance sensor 1101 would be provided near the camera 103. This is because, if the distance sensor 1101 is disposed far from the camera 103, the difference between the distance between the camera and the paper surface and the distance between the distance sensor and the paper surface risks to grow large and the distance d704 between the camera and the paper surface becomes an inaccurate value.

The cellular phones shown in FIG. 7-11 are examples of information processing apparatuses. The present subject matter is not limited to the cellular phone. The techniques are used in not only a cellular phone but also other information processing apparatuses.

FIG. 12 is a flowchart showing the inclination operation of an information processing apparatus. Here, the case of correcting the inclination of the camera 103 during the monitoring of the recognition object will be explained. The expression “during the monitoring” means that no indication has been given on the decision to pick up images or the specification of the recognition object after the camera function was put in motion by the camera.

Step S1201 is a state in which the information processing apparatus is in an awaiting state for awaiting an input of a key or a reception of a signal or the like. When the key input for starting the camera function is detected by the CPU 102 (step S1202), the variables relating to the camera function stored in the memory 104 are initialized and other operations for starting the camera function are carried out (step S1203). Then, the CPU 102 judges whether the image pickup mode is the recognition mode or the ordinary image-taking mode.

Then, the distance sensor 1101 measures the distance between the paper surface and the camera 103 (step S1204), and the result is stored in the memory 104. The CPU 102 reads the measurement stored at the memory 104 and calculates the inclination θ from the measurement (step S1205). Then, the CPU 102 sends an angle correction signal requesting that the orientation of the camera 103 be corrected to the inclination θ to the angle correction part 901, and the angle correction part 901 having received the angle correction signal corrects the inclination of the camera 103 to θ in response to the angle correction signal (step S1206).

Then, the camera 103 acquires an image and stores temporarily the same in the memory 104 (step S1207). The CPU 102 reads the image and corrects the image information distorted due to the fact that it was taken obliquely by using the distance between the camera 103 and the paper surface that had been measured by the distance sensor and stores the same in the memory 104 (step S1208). Here, “the keystone correction method” is used to correct the distortion as a means of correction.

The CPU 102 reads the image and displays the same on the display 107 (step S1209).

Then, the CPU 102 judges whether the shutter key had been depressed or not (step S1210) .When no depression of the shutter key is detected, it returns to the step S04 and repeats the same process.

When the input of the shutter key is detected in the step S1210, the camera 103 picks up the image of the subject (step S1211) and the CPU 102 recognizes characters by using the image (step S1212). And the result is displayed on the display 107 (step S1213).

Such an automatic correction of the inclination of the camera 103 as required enables the apparatus to make the characters appearing on the paper and those displayed on the display 107 look as if they were at the same position. It also enables the user to easily select the string of characters as the object of character recognition, the whole system will be easier to operate and user-friendly.

It is preferable to allow the user to select a prohibition mode which prohibits the camera 103 from inclining. When the user selects the mode, the operation procedure shown in FIG. 2 skips to the step S1209 after the step S1203.

FIG. 11(a) shows the case of only one distance sensor being provided besides the camera 103. However, it is possible to provide another distance sensor on the upper part of the back side of the housing 110. FIG. 11(b) shows the case that the cellular phone has another distance sensor 1104 including a light projection part 1105 and a light reception part 1106. In this case, the measurements of the two distance sensors and the design value of the housing 110 (longitudinal length) can be used to calculate the angle formed by the display 107 and the paper surface on which characters to be recognized appear. The use of this angle enables correction of the image displayed on the display 107 even if the display 107 is not disposed in parallel with the paper surface. Besides, any number of distance sensors, however many, can be mounted on the information processing apparatus provided that it is possible to do so.

Moreover, the information processing apparatus may have an acceleration sensor. An acceleration applied on the apparatus is measured by acceleration sensor. The inclination of the camera 103 is calculated by using the measured acceleration. The acceleration sensor comprises a heater for heating a part of gases such as nitrogen or carbon dioxide confined in a space, a thermometer for measuring the temperature of the gas, etc. When an acceleration is applied to the acceleration sensor, a part of the gas whose temperature has risen as a result of the heating by the heater and other gas whose temperature has not risen change their position and as a result the distribution of temperature changes. This distribution of temperature is measured by a thermometer, and in this way the acceleration applied on the sensor is measured. From this measurement of acceleration, the inclination of the acceleration sensor in the perpendicular direction can be calculated.

Normally, a size of the acceleration sensor is smaller than that of the distance sensor. Using the acceleration sensor may make the information processing apparatus more compact.

FIG. 13 is a flowchart of character recognition operations. Here, the steps S1305-S1311 are detailed procedure of the step S1212 of FIG. 12.

When the camera 103 outputs an image data of the subject (step S1211), the CPU 102 obtains the image data (step S1305). The CPU 102 extracts an area of a string of one or more characters included in the image data (step S1306). When an interval between an assembly of black pixels and another assembly of black pixels of the image data is equal to or more than a given value, the CPU 102 decides that such assembly is a string of characters set off by spaces. The coordinates of the area of character string thus extracted are stored in the memory 104. When the CPU fails to extract the area of the character string (step S1307), the procedure goes to the step S1210. In this case, it is preferable to notify the user of the failure of extraction of the recognition area.

When the area of the character string is extracted, the CPU 102 recognizes a string of one or more characters in the extracted area (step S1308).

Then, the CPU 102 determines a type of the recognized character string (step S1309). The type of the recognized character string includes such as an e-mail address, a telephone number, an URL, or an English word, or a Japanese word. The method of recognition of the type of the recognized character string is as follows. For example, “e-mail address” if “@” is included in the string of characters, “URL” if “http:” is included, “telephone number” if the string of characters is formed by numbers and “−”, and an English word if it is composed entirely by alphabetical letters. Furthermore, when the string of characters includes such words as “Tel:” “Fax:” or “E mail:” they can be used for discrimination.

The user selects the type of character string such as an email address or a telephone number or the like before the step S1210, though the step for input the type is not shown in FIG. 13. The CPU 102 judges whether the type of recognition object that the user had previously set and the type of character string actually recognized coincide or not (step S1310). When they match, the display 107 displays a frame around the extracted area (step S1311). When the user manipulates the input unit 101, the recognition result is displayed (step S1312). In this case, if an arrangement is made to display automatically the recognition result in the display 107 not through any given operation specially by the input unit 101, the user needs not input anything and the operability of the whole system may improve.

When the type of recognition object set and the type of string of characters recognized do not match in step S1310, the CPU 102 shifts the starting point of extracting an area of a character string within the image (step S1313), and executes the extraction processing again (step S1306).

Here, in the case of executing the extraction processing of an area of a character string successively from the upper row to the lower row, the CPU 102 in step S1313 processes to shift downward by a given amount the starting point of extracting. And in anticipation of the case of a plurality of e-mail addresses or telephone numbers being listed in a row, the presence of any space results in the preceding and succeeding strings of character being treated as different ones.

In this case, after the processing described from step S1308 to step S1310 is completed with regard to the string of characters on the left side of the blank space, a similar processing is executed for the string of characters on the right side of the blank space.

In addition, it is possible to execute the extraction processing of character row for all the characters contained in the image and then to execute the processing subsequent to the character recognition processing. In this case, it is possible to store in the memory 104 the results of character extraction, for example the coordinates in the upper left and lower right side of the extracted characters in the image, and then execute successively the processing described in step S1308 through step S1312 for each string of characters.

It may be difficult for the user to point to a correct place of a recognition object by using the input unit 101. In this example, the CPU executes the extraction procedure again when the recognition result does not match with the type of the recognition object. Therefore, the user does not have to manipulate the input unit 101 to point to the recognition object place.

FIG. 14 shows examples of screen for selecting the type of recognition objects. FIG. 14 (a) represents the screen after the camera start. When the “sub-menu” key is depressed in this state, a menu relating to camera and character recognition is displayed (FIG. 14 (b)). When “(2) the recognition object setting” is selected in this state, a screen for selecting the type of recognition object is displayed (FIG. 14 (c)). When for example “(3) Telephone number” is selected in this state, a screen informing the user that the telephone number is set for the type of recognition object is displayed.

FIG. 15 (a) represents an example of screen when a name card 1503 is monitored after setting “telephone number” as the type of recognition object by executing an operation as described above. The telephone number “045-000-1234” enclosed by a frame 1504 among the characters displayed on the screen is recognized by the CPU 102, and the recognition result is displayed in the recognition result display area 1505. The icon 1501 shown in FIG. 15 (a) is an icon informing the user that the “telephone number” is set as the type of recognition object. On finding this icon, the user can confirm that the type of recognition object is now “telephone number.”

FIG. 15 (b) represents an example of screen when a name card 1503 is monitored after setting “mail address” as the type of recognition object. In this case, a mail address “yamada@denki.OO.co.jp” enclosed by a frame 1506 is recognized by the CPU 102, and the recognition result thereof is displayed as shown by 1507. And an icon 1502 is displayed to inform the user that the type of recognition object is “mail address.”

As described above, when the screen being monitored contains the type of recognition object previously selected, for example, “mail address”, it is automatically extracted and the recognition result is displayed. By this arrangement, the user can save the trouble of correcting the position to specify the recognition object at the time of character recognition, and the operability of the whole system may be improved.

And when there are a plurality of character stings chosen as the recognition objects in a screen, for example when two mail addresses are displayed, both of them can be recognized and the recognition results thereof can be displayed. An example of display screen in this case is shown in FIG. 15 (c).

As shown in FIG. 15 (c), the mail addresses chosen as the recognition objects are numbered by for example “(1),” “(2),” etc. as shown in 1508 and 1509. And by numbering the recognition result of the mail address corresponding to “1” by “(1)” and the recognition result of the mail address corresponding to “2” by “(2),” the relationship of correspondence between the mail address chosen as the recognition object and the recognition result can be easily understood, and this may improve the operability of the whole apparatus.

In addition, when there are a plurality of mail addresses and all the recognition results cannot be displayed, it is possible to display the recognition result of the mail addresses corresponding to the numbers by depressing the number key corresponding to (1) and (2). For example, when the “1” key is depressed, “yamada@denki.OO.co.jp” is displayed in the recognition result display area. And when the “2” key is depressed, “taro@xxx.ne.jp” is displayed. By making such an arrangement, even if the screen is small as one mounted on a cellular phone, a plurality of recognition results can be easily displayed, enhancing the convenience of the apparatus.

And as shown in FIG. 15 (d), an initial input area 1512 is provided. When the user inputs an alphabetical letter into the initial input are 1512 by depressing the input unit 101, the CPU 102 extracts a mail address beginning with the letter. It then displays the recognition result of the mail address in the recognition result display area by displaying a frame over the mail address extracted. In FIG. 15 (d), a mail address beginning with “y” inputted by the user from among a plurality of mail addresses as an initial letter “yama@xxx.OOO.co.jp” is chosen as the recognition object.

Thus, it is possible to select easily and quickly a mail address or addresses that the user wishes to display as the result of recognition from among a plurality of recognition objects. This may improve the operability of the whole system and the convenience for the user.

Of course, the functions shown in FIG. 15 (c) and FIG. 15 (d) can be combined.

And, when there are a plurality of candidates for recognition objects, it is possible to make an arrangement for selection through a cross key or other component of the input unit 101. By adopting such an arrangement, it is possible to easily specify the recognition object even if there are a plurality of recognition objects as mentioned above after the type of recognition object is chosen. Therefore, the whole system may be easier to use. Furthermore, if there are a plurality of mail addresses beginning with the initial “y” in the mode of top character search described above, in the first place the recognition objects are roughly selected by the top character search, and then the mail address that the user really wants to search can be easily selected by means of a cross key. Therefore, the whole system will be easier to use and more convenient.

And it is possible to make an arrangement to store the recognition results in an address book in the memory 104. By this arrangement, it is possible to register mail addresses and other individual information contained in a business card or the like without the necessity of obliging the user to input such data and therefore the whole apparatus will be easier to use and more convenient.

The functions similar to those shown in FIG. 15 (d) can be used as the character search function of recognition objects. For example, suppose that the user already knows that an English newspaper contains an article related to patent, but he or she does not know in which part of the paper the article appears. In such a case, it is enough to search a word “patent, but the process of searching for that word in an English newspaper written with several tens of thousands of words is tiresome and boring. The following is an explanation of the case of the user inputting some or all the key words that he or she wants to search (hereinafter referred to as “the search object word”), and search the location of the key word used in a newspaper or a book or the like.

When some or all the search object words are inputted, search words specification data for specifying the words to be searched are inputted into the CPU 102. And the CPU 102 having received the research words specification data searches the words specified as the objects of search from among the words contained in the image information acquired by the camera 103 based on the research words specification data. When there are words data including the search words specification data in the image information acquired by the camera 103, the CPU 102 informs the user that the search object words have been searched.

As for the mode of notification, for example, it is possible to adopt the mode of displaying the words chosen as the search objects by encircling the same with a frame. When there is no word data including search words specification data within the image information acquired by the camera 103, the CPU 102 informs the user to that effect by displaying, for example, “The word chosen as the search object has not been found.”

Such search may be limited to a given length of time. By adopting such an arrangement, it is possible to put an end to a search when the search time is long, and as a result to save wasteful time.

FIG. 16 is an illustration showing examples of display screens. For example, an example of display screen wherein the word “parameter” alone is framed is shown.

FIG. 16 (a) is an example of screen display wherein an English text is monitored by inputting a top character “p” in the top character input area 1601. The user can input initials by depressing several times on the input unit 101. In this screen, English words starting with the initial “p”, for example portion”, “parameter” and “pattern” are respectively framed.

The following FIG. 16 (b) represents an example of screen display wherein an English text is monitored when “para” is inputted in the initial input area. In this screen, the word “parameter” alone is framed, and the user can easily identify the position where the word“parameter” is printed and its number. In this case, it is possible to make an arrangement for indicating the number of the word “parameter” appearing on the paper.

When the information processing apparatus is shifted to the right in this state, the word “parameter” printed on the right side of the English text is framed (FIG. 16 (c)).

By a simple operation of shifting the cellular phone in this way, the position of the word chosen for recognition (“parameter”) can be determined. And thus, it is possible to search easily characters in a printed matter containing a multitude of character information. Accordingly, the trouble of specially search any specific characters may be eliminated, and the whole apparatus is very easy to operate and convenient.

Moreover, it is also possible to make an arrangement to display information related to the searched word such as the meaning and translation of the word.

FIG. 17 is a flowchart of processing of the information processing apparatus. In this example, dictionary data 109 is stored in the memory 104. Here, the steps S1305 and S1701-S1709 are detailed procedure of the step S1212 of FIG. 12. For example, the string of one or more characters closest to the “+” mark displayed in the center of the display 107 is extracted and the character string is chosen as the object-of-recognition word (step S1701). And the CPU 102 encircles the character string specified as the object-of-recognition words with a frame, and informs the user of the character string specified currently as the objects of recognition (step S1702).

Then, the CPU 102 executes a character recognition processing (step S1703), extracts a word contained in the image data for character recognition, and stores the result of recognition in the memory 104 (step S1704).

The CPU 102 reads from the memory 104 the recognition result, and searches the word that match with the result of recognition from the dictionary data 109 (step S1705).

As a means of searching, it is preferable to find out first of all the words of which the string of characters matches completely and, if there is no word matching completely, to try to find out words of which one character is different but other characters coincide. Even if the CPU 102 commits an error in the recognition of characters, the word closest to the string of letters can be found. The trouble of repeating character recognitions many times may be eliminated and the whole system is easy to operate and convenient.

And when even words containing only one different character cannot be found, words containing two different characters, words with three different characters, and words with a gradually increasing number of different characters can be searched. In this case, even if the ratio of recognition is low, appropriate words may be found.

When matching words are found in the dictionary data 109 by the search, the CPU 102 reads the information corresponding to the word, such as a definition of the word, from the dictionary data 109 (step S1707). The result of the recognition and the information read out from the dictionary data 109 is displayed on the display 107 automatically without any input operation (step S1213). On the other hand, when no matching word is found in the dictionary data 109, a display reading “No corresponding word is found” is displayed on the display 107 (step S1709).

In this example, the character recognition and the search are executed after the input unit 101 such as the shutter button is manipulated by the user. However, this invention is not limited to this example. The character recognition and the search may be executed every time the user shifts the information processing apparatus shown in FIG. 18.

FIG. 18 (a) represents an example of display screen wherein a definition of the word “length” is displayed on the display 107.

FIG. 18 (b) represents an example of display screen wherein the information processing apparatus is shifted to the right and a definition of the word “width” is displayed on the display 107.

Thus, it is possible to refer the information related to the word chosen as objects of recognition by shifting the apparatus without the necessity of the user depressing any buttons, and the whole system may very easy to use and convenient.

In this case, because of processing capacity, a time lag may appear between the framing of the word chosen as the object of recognition and the display of the corresponding information. When the object of recognition changes from a word to another, the object of recognition after the change is framed, but the corresponding definition may remain the same as that of the object of recognition before the transition. This is an embarrassing situation for the user also. And in order to solve this problem, it is enough to devise a system whereby the CPU 102 frames the word chosen as the object of recognition and displays the corresponding definition at the same time. In this case, for example, as it normally requires more time to display the definition and to frame a word, the CPU 102 should be given the task of coinciding the timing of displaying the information to that of framing. By this arrangement, the timing of framing of the word chosen as the object of recognition and that of displaying the definition coincide, and therefore the user may see what word is selected as the object of recognition now and what is the definition corresponding thereto. Thus, the whole system may be very easy to use and convenient.

Next, an exemplary system for exploring the definition of words used in a book or a magazine or the like will be described. In stories, special proper nouns not listed in ordinary dictionaries can appear, and words listed in dictionaries are often used with a special meaning in some stories. Readers who encounter such words are unable to find out the meaning of such words by referring to dictionaries have no other choice than to read carefully the whole book from the beginning or to question a friend having a good knowledge on the story.

In order to solve this problem, the inventors propose a system for exploring the definition of words, in this example, using an identification information such as an ISBN (international standard book number) printed on a book or the like. Here, the ISBN stands for the “international standard book number” that can be used to identify a specific book among the books issued in the whole world. The following example, the ISBN is used for exploring definitions of words. However, this embodiment is not limited to use of the ISBN, other identification information is used for exploring information related the recognized character storing.

FIG. 19 is a diagram showing an example of a system for exploring the definition of words.

The dictionary data 109 contains English dictionary data and other foreign language dictionary.

The server 1950 comprises component parts as shown in FIG. 19. SV-CPU 1902 operates based on the programs stored in SV memory 1904, and controls various parts in response to the signals coming from for example SV communication interface 1906. The SV memory 1904 stores the data received from the communication interface and other data handled by the server 1950.

The ISBN dictionary data 1905 are dictionary data containing the proper nouns and words used only in the book shown by the ISBN and whose meaning is different from the normal meaning. A dictionary ID is allocated to each word of the ISBN dictionary data 1905, and the dictionary ID manages the ISBN dictionary data 1905.

The ISBN-dictionary ID correspondence table 1903 is a table indicating the relationship between the ISBN and the dictionary IDs of the ISBN dictionary related with the books bearing the ISBN.

FIG. 20 shows an example of the ISBN-dictionary IDs correspondence table 1903. The ISBN-dictionary IDs correspondence table 1903 consists of, for example, ISBN 2001, book titles, publishers and other book information 2002 and dictionary ID 2003, and the titles and publishers of books may be explored by the ISBN. Here, the book information is information related with books and is not limited to those mentioned above.

The SV communication interface 1906 executes communication with the information processing apparatus or other device via a network. The SV input unit 1901 represents a key board, a mouse and other input apparatuses used for storing and renewing the ISBN-dictionary IDs correspondence table 1903 and ISBN dictionary data 1905 in the SV memory 1904.

The SV display 1907 is an output apparatus for displaying the data stored in the SV memory 1904.

The process required to register and make available the dictionary corresponding to the ISBN will be described with reference to FIG. 21.

The CPU 102 of the information processing apparatus 100 executes the character recognition processing (step S2100), stores the recognition result data in the memory 104 and displays the recognition result on the display 107.

The CPU 102 reads the recognition result data from the memory 104, determines whether it is the ISBN or not (step S2101), and stores the result of the determination in the memory 104. When the character string includes a numeral character and a hyphen with hyphens inserted at positions different from telephone numbers, or the character string begins with “ISBN.”, the CPU 102 determines that the character string is the ISBN.

When the recognition result is determined not as an ISBN in the step S2101, the CPU 102 displays the display screens allocated for each type of the objects of recognition thereof (step S2102). For example, when the type of recognized character string is mail address, the CPU 102 displays the display screens related to mail, and when the type of recognized character string is URL, it displays the display screens related to URL.

When the recognition result is determined as an ISBN in the step S2101, the CPU 102 displays the dedicated screen for the case wherein the recognition object is an ISBN.

When the recognition result is determined as an ISBN, the CPU 102 transmits ISBN data to the server 1950 via the communication interface (step S2103).

The SV communication interface 1906 of the server, having received ISBN data (step S2104), temporarily stores the data at the SV memory 1904. The SV-CPU 1902 reads out the ISBN data, and searches whether the correspondence table 1903 contains any ISBN (step S2105).

When the received ISBN is not found in the correspondence table 1903, the SV-CPU 1902 transmits an error message to the apparatus 100 to inform that the dictionary ID corresponding to the received ISBN does not exist in the server (step S2110).

On the other hand, when the received ISBN is found in the correspondence table 1903, the SV-CPU 1902 reads the dictionary ID 2003 corresponding to the ISBN from the correspondence table 1903. The dictionary ID 2003 is transmitted to the apparatus 100 via the SV communication interface (step S2106).

The apparatus 100 stores the dictionary ID 2003 in the memory 104 (step S2107), and displays that the dictionary corresponding to the ISBN recognized existed on the server (step S2108).

By the process described above, the user of the information processing apparatus 100 can take advantage of the dictionary corresponding to the ISBN contained in the server by using the dictionary ID 2003, and thus can reduce the storage capacity. At the same time the whole system becomes easier to use and convenient.

In this example, the dictionary ID 2003 is downloaded instead of the dictionary corresponding to the ISBN itself. However, it is possible to adopt a process whereby the dictionary corresponding to the ISBN itself is downloaded to be stored. Thus, once the dictionary is stored in the appratus 100, the communication time with the server 1950 for referring to the dictionary can be saved.

It is also possible to adopt a process whereby, in connection with the downloading of the dictionary ID of the dictionary corresponding to the ISBN, the information related with the books corresponding to the ISBN, for example book titles are downloaded at the same time.

In this case, the dictionary ID and book information received from the server 1950 are linked together and stored in the memory 104. For example, the book information corresponding to the dictionary ID is displayed before, after and while referring to the ISBN dictionary data by using the dictionary ID.

By adopting this process, the user can confirm to which books the dictionary corresponding to the ISBN is related before, after and while referring to the dictionary. Therefore, for example the user who is using a dictionary different from the desired one can easily notice of the fact, making the whole system convenient and easy to use. In this connection, if a system is adopted whereby the user can reselect another dictionary of its liking, the system will be more convenient and easier to use.

An example of checking the meaning of words by using the dictionary will be described with reference to the flowchart in FIG. 22. Here, dictionary data 109 containing the meaning of ordinary words are previously stored in the apparatus 100, and the case of searching the dictionary corresponding to the ISBN related to special words not contained in the dictionary data 1908 will be described.

To begin with, as described above, the CPU 102 executes character recognition processing on the words selected as the objects of recognition, stores the recognition result data in the memory 104 and displays the recognition result in the display 107 (step S2201). The CPU 102 searches matching words from the words contained in the dictionary data 109 (step S2202).

If an appropriate word is found as a result of the search, the meaning data or translation data relating to the word (hereinafter referred to as meaning/translation data) are read from the dictionary data 109, and are displayed in the display (step S2211).

If no appropriate word is found as a result of the search, the CPU 102 reads out the dictionary ID 2003 stored in the memory 104. The CPU 102 transmits the recognition result data and the dictionary ID 2003 through the communication interface 106 to the server 1950 (step S2204).

When the server 1950 receives the recognition result data and the dictionary ID 2003 (step S2205), the SV-CPU 1902 accesses the ISBN dictionary data 1905 correlated with the dictionary ID 2003 (step S2206). And the SV-CPU 1902 searches words matching with the recognition result data from the ISBN dictionary data 1905 (step S2207).

At that time, the SV-CPU 1902 determines whether any words matching with the recognition result data are contained or not in the ISBN dictionary data 1905 (step S2208). If no word matching with the recognition result data exists in the ISBN dictionary data 1905, the SV-CPU 1902 transmits an error message to the apparatus 100 via the communication interface 1906 (step S2212).

On the other hand, when an appropriate word is found in the step S2208, the SV-CPU 1902 reads the meaning/translation data stored in the SV-memory 1904. The SV-CPU 1902 transmits the meaning/translation data through the SV communication interface 1906 to the apparatus 100 (step S2209). The information processing apparatus 100 receives the meaning/translation data through the communication interface 106 (step S2210), and displays the meaning/translation data on the display 107 (step S2211).

FIG. 23 shows examples of screen display of the information processing apparatus. FIG. 23 (a) represents an example of screen display wherein the ISBN data is displayed as a recognition result.

When the operating key corresponding to the “sub-menu” shown in the lower right of the display screen is depressed in the state shown in FIG. 23 (a), the sub-menu relating to the character recognition will be displayed (FIG. 23 (b)).

Then, when “(3) obtain book information” is selected, the recognized ISBN data and a demand signal demanding the dictionary data or the dictionary ID corresponding to the ISBN are transmitted to the server 1950. And, for example, as shown in FIG. 23 (c), the state of connection with the server 1950 is displayed.

Then, FIG. 23 (d) represents an example of display screen when the dictionary ID of the specific dictionary corresponding to the ISBN and the book information corresponding to the ISBN are received from the server 1950. Here, the book information includes a title, publisher and author of the book. The information also includes the availability of a dictionary correspond to the book.

By this information, the user can easily confirm whether any book information corresponding to the ISBN and a dictionary corresponding to the ISBN exist in the server.

And when “(4) dictionary available” is chosen in this state, the screen changes to one where the user is required to choose whether he or she wishes to register the dictionary ID received from the server as an auxiliary dictionary in the memory 104 or not (FIG. 23 (e)). Here, the term “auxiliary dictionary” means a dictionary used as a supplement to the dictionary data 109 mainly used.

When “1. Yes” is chosen in this state, the dictionary IDs are registered as the auxiliary dictionary. Here, the registration processing can be, for example, a processing of substituting variables representing the auxiliary dictionary stored in the memory 104 by the values of dictionary IDs received from the server. Then a message informing the user that the dictionary had been registered in the auxiliary dictionary will be displayed (FIG. 23 (f)).

A description above related to the case shown in FIG. 23 (d) where, when “(4) dictionary available” is chosen, the dictionary IDs of the dictionary corresponding to the ISBN are registered. However, it is possible to adopt a process wherein, as mentioned above, the dictionary itself corresponding to the ISBN is received to be stored in the memory 104.

Alternatively, it is possible to adopt a method of receiving the dictionary IDs or the dictionary itself through a memory card or other memory media.

By adopting such methods, the communication cost and time spent for connecting with the server can be eliminated.

And now, examples of display screens displaying the meaning of words by using a dictionary corresponding to the ISBN are shown in FIG. 24.

FIG. 24 (a) shows an example of display screen showing the recognition results. Here, the display screen shows that the word “Zakky” chosen as the object of recognition has been recognized. Moreover, a facility is offered to select between using the dictionary data 109 (hereinafter referred to as “the main dictionary”) for checking the meaning of this word “Zakky” or using the ISBN-corresponding dictionary data (hereinafter referred to as “the auxiliary dictionary”) (2401, 2402).

By using this facility, for example, in the case of a word clearly not registered in the main dictionary, it is possible to select the auxiliary dictionary from the beginning. On the other hand, in the case of a word highly likely to be registered in the main dictionary, the auxiliary dictionary is not chosen but the main dictionary is chosen from the beginning to find out whether the meaning of the word is contained therein or not. By the provision of such a facility, the user can select either the main dictionary or the auxiliary dictionary on each occasion, and this is user-friendly and convenient.

FIG. 24 (b) is an illustration showing a case wherein an attempt to use the main dictionary to look for the meaning of a word ended up with the discovery that the main dictionary does not contain the word chosen as the object of recognition (here “Zakky”). Here, the CPU 102 processes to secure an area to display a pop-up screen to show that the word is not found in the main dictionary by shifting upward the area for displaying the recognition result. By this process, the display screen may be effectively used.

FIG. 24 (c) represents an example of display screen wherein the use of the auxiliary dictionary (2402) is selected in the case where the main dictionary does not contain the word chosen for the recognition object. Here, the auxiliary dictionary contains the word “Zakky,” and the CPU 102 processes to display the meaning of the word “Zakky.”

FIG. 24 (d) is an example of display screen wherein neither the main dictionary nor the auxiliary dictionary contains the word “Zakky.” Here, the screen displays to that effect.

FIG. 24 (e) is an example of display screen wherein a different dictionary is chosen when neither the main dictionary nor the auxiliary dictionary contains the word chosen as the recognition object “Zakky.” When a “dictionary 2403” is chosen from the state displayed in the display screen of FIG. 24 (d), the screen shifts to the one displayed in FIG. 24 (e). Here, the data of a plurality of dictionary IDs or dictionaries themselves are contained in advance in the memory 104. And the facility is offered for setting either the main dictionary or the auxiliary dictionary from this state.

By the offer of this facility, for example, when the user wants to use a dictionary different from the one containing the word chosen as the recognition object, it is possible to reselect the dictionary, and the possibility of grasping the correct meaning is enhanced.

Besides, the facility offered for setting the main dictionary and the auxiliary dictionary shown in the example above is not limitative, and it is possible to offer the facility of setting only one dictionary. For example, it is possible to adopt an arrangement wherein the main dictionary is a fixed dictionary and only the auxiliary dictionary can be changeable or set freely. By adopting this arrangement wherein a random change of dictionary is not allowed, it is possible for example to prevent an unnecessary confusion over which is the main dictionary because of frequent change of dictionaries.

FIG. 24 (f) represents an example of display screen wherein the information of what is the currently set as the auxiliary dictionary is offered to the user. Here, the presently set auxiliary dictionary (here, Hello! Zakky: 2404) is displayed over the icon for choosing the auxiliary dictionary.

By the offer of this facility, the user can visually and simply confirm the currently set auxiliary dictionary and other items, and this is user-friendly and convenient.

Incidentally, the means of notification is not limited to the one described above. For example, a number or an icon representing the auxiliary dictionary may be used. By this method, in a cellular phone whose display screen is relatively small, the display area can be used effectively.

And the above description related to the setting of auxiliary dictionaries. However, it is obviously possible to offer the facility of informing the user what is the currently set as the main dictionary.

Furthermore, it is possible to realize various functions described above in the form of software programs, and the user can receive the software programs through a machine-readable media from a server of a information provider or any other data device via a data network. The machine-readable media includes, for example, a floppy disk, a flexible disk, hard disk, magnetic disk, magnetic tape, any other magnetic medium, a CD-ROM, DVD, any other optical medium, a RAM, a PROM, and EPROM, a FLASH-EPROM, any other memory chip or cartridge, a carrier wave transporting data or instructions. In this way, it will be easy to mount only necessary functions, or add or delete or renew various functions depending on the preference of the user.

In addition, it is obviously possible to combine the modes of carrying out described above to constitute a new mode or modes of carrying out.

And the present invention is not limited to the modes of carrying out described, and the principles and the new characteristics disclosed herein include a wide scope of arts.

1. An information processing apparatus comprising:
a camera which outputs picture information of an object;
a display which displays a image using the picture information output from the camera; and
an input unit which allows a user to select one mode of the camera from a plurality of modes including an ordinary image-taking mode to take a picture as an ordinary camera function and a recognition mode to recognize a character included in a picture information output by the camera;
wherein the camera is positioned to make a displayed image of the object substantially consistent with a view of the object by a user.

2. The information processing apparatus according to claim 1, wherein the camera is disposed on a back surface facing away from a surface where the display is disposed, and the camera is located near the point at the intersection of the back surface with a line drawn from the center of the display towards the normal line of the display.

3. The information processing apparatus according to claim 1, wherein the camera is inclined when the recognition mode is selected.

4. An information processing apparatus comprising:
a camera which outputs picture information;
an input unit which allows a user to select one mode of the camera from a plurality of modes including an ordinary image-taking mode to take a picture as an ordinary camera function and a recognition mode to recognize a character included in a picture information output by the camera; and
a CPU which controls movement of the camera if the recognition mode is selected by the selector and recognizes a string of one or more characters included in picture information output by the camera in response to a character recognition request inputted through operation of the input unit.

5. The information processing apparatus according to claim 4, wherein the CPU moves the camera so that the camera is inclined, if the recognition mode is selected through operation of the input unit.

6. The information processing apparatus according to claim 5, wherein the CPU does not incline the camera if the ordinary image-taking mode is selected through operation of the input unit.

7. The information processing apparatus according to claim 4, further comprising a display which displays a picture,
wherein the CPU processes picture information output by the camera so that at least one part of display location of the picture information is modified and the display displays the processed picture information as a viewfinder in the recognition mode.

8. The information processing apparatus according to claim 7, wherein the CPU does not process picture information output by the camera so that at least one part of display location of the picture information is modified in the ordinary image-taking mode.

9. The information processing apparatus according to claim 4, further comprising a communication interface for communication via a network,
wherein the CPU controls the communication interface so that identification information included in the recognized character is transmitted in response to a transmission request inputted through operation of the input unit.

10. The information processing apparatus according to claim 9, wherein the CPU controls the display so that information related to the identification information received by the communication interface is displayed.

11. The information processing apparatus according to claim 9, wherein the identification information includes an ISBN data, a URL, or an email address.

12. The information processing apparatus according to claim 10, wherein the information related to the identification information includes a dictionary data or an ID data related to a dictionary data.

13. The information processing apparatus according to claim 4, wherein the input unit allows a user to input an information type, and the CPU recognizes a string of one or more characters corresponding to the information type input by the input unit if present in the picture information input by the camera.

14. The information processing apparatus according to claim 13, wherein the CPU controls the display so that a notification is output when the picture information does not include a string of one or more characters correspond to the information type input by the input unit.

15. An information processing apparatus comprising,
a picture interface which inputs picture information into the information processing apparatus;
an input unit which inputs a selection of an information type;
a CPU which extracts a string of one or more characters corresponding to the information type input by the input unit if present in the picture information input by the picture interface, in response to a character recognition request by a user.

16. The information processing apparatus according to claim 15, wherein the CPU outputs a notification to the user when the picture information does not include a string of one or more characters corresponding to the type input by the input unit.

17. The information processing apparatus according to claim 15, further comprising a communication interface for communication via a network,
wherein the CPU controls the communication interface so that identification information included in the recognized character string is transmitted in response to a transmission request by a user.

18. An information processing apparatus capable of recognizing characters comprising:
a camera which outputs picture information of an object; and
a display which displays a image using the picture information output from the camera;
wherein the camera is disposed on a back surface facing away from a surface where the display is disposed, and the camera is located near the point at the intersection of the back surface with a line drawn from the center of the display towards the normal line of the display.

19. An information processing method comprising the steps of:
selecting one mode of picture information input from a plurality of modes including an ordinary image-taking mode to take a picture as an ordinary camera function and a recognition mode to recognize a string of one or more characters included in input picture information;
processing input picture information so that at least one part of display location of the input picture information is modified if the recognition mode is selected; and
displaying the modified picture information as a viewfinder.

20. An information processing method comprising the steps of:
receiving a picture information;
inputting an information type;
extracting a string of one or more characters corresponding to the inputted information type from the picture information in response to a character recognition request by a user.

21. A software product comprising executable programming code, wherein execution of the programming code causes an information processing apparatus to implement a series of steps, comprising:
selecting one mode of camera operation from a plurality of modes including an ordinary image-taking mode to take a picture as an ordinary camera function and a recognition mode to recognize a string of one or more character included in a picture information by the camera;
controlling a camera so that the camera is inclined if the recognition mode is selected; and
recognizing a string of one or more characters included in picture information output by the camera in response to a character recognition request by a user.

22. The software product according to claim 21, further comprising the steps of:
processing the input picture information so that at least one part of display location of the input picture information is modified so as to compensate for camera inclination if the recognition mode is selected; and
displaying the modified picture information as a viewfinder.

23. A software product comprising executable programming code, wherein execution of the programming code causes an information processing apparatus to implement a series of steps, comprising:
receiving a picture information;
receiving an input of an information type;
extracting a string of one or more characters corresponding to the inputted information type from the received picture information in response to a character recognition request by a user.

24. An information processing method comprising the steps of:
receiving a picture information;
recognizing a string of one or more characters from the picture information;
transmitting identification information included in the recognized character string when an user requests for information related to the recognized character;
receiving information related to the identification information;
displaying the received information.

25. The information processing method according to claim 24, wherein the identification information includes an ISBN data, a URL, or an email address.
